(19) United States
(12) Patent Application Publication
(10) Pub. No.: US 2026/0085142 A1
(43) Pub. Date: Mar. 26, 2026

(54) GRAFT POLYARYLETHER COPOLYMERS

(71) Applicant: Solvay Specialty Polymers USA, LLC, Alpharetta, GA (US)

(72) Inventor: Kamlesh P. NAIR, Alpharetta, GA (US)

(21) Appl. No.: 19/112,622

(22) PCT Filed: Sep. 21, 2023
(86) PCT No.: PCT/EP2023/076141

§ 371 Date: Mar. 18, 2025

Related U.S. Application Data
(60) Provisional application No. 63/409,989, filed on Sep. 26, 2022.

(30) Foreign Application Priority Data
Dec. 5, 2022 (EP) 22211450.6

(51) Int. Cl. C08F 283/00; B01D 71/52; B01D 71/68; B01D 71/78; B01J 39/20; B01J 47/12; C08F 283/06; C08G 65/40

(52) U.S. Cl. CPC C08F 283/00; B01D 71/5221; B01D 71/68; B01D 71/78; B01J 39/20; B01J 47/12; C08F 283/065; C08G 65/4025; C08G 2650/40

(57) ABSTRACT

The invention relates to a graft polyarylether (‘PAE’) copolymer (P1), a process for preparing the graft PAE copolymer (P1) from a side-chain allyl/vinylene-functionalized PAE copolymer (P0) via free radical reaction with vinyl pyrrolidone, and the use of the graft PAE copolymer (P1) in the preparation of an article, such as a membrane or a part thereof. The graft PAE copolymer (P1) comprises at least two types of recurring units, one of which having side-chain grafted poly(vinylpyrrolidone). The invention also relates to an amorphous side-chain allyl/vinylene-functionalized polyaryletherketone copolymer (P0).

### CROSS-REFERENCE TO RELATED APPLICATIONS

This application claims priority to U.S. patent application No. 63/409,989 filed on Sep. 26, 2022 and European patent application No. 22211450.6 filed on Dec. 5, 2022, the whole content of these applications being incorporated herein by reference for all purposes.

### TECHNICAL FIELD

The present disclosure relates to a graft polyarylether copolymer (P1), to a process for manufacturing the graft copolymer (P1) from an amorphous side-chain allyl/vinylene-functionalized polyarylether copolymer (P0), to articles, in particular membranes, comprising such copolymer (P1) and to the use of the copolymer (P1) for preparing such articles. The present disclosure also relates to an amorphous side-chain allyl/vinylene-functionalized polyaryletherketone copolymer (P0) and its corresponding graft polyaryletherketone copolymer (P1).

### BACKGROUND ART

Poly(arylethersulfone) (PAES) polymers are also high performance polymers with high mechanical strength and high thermal stability; they are used in a variety of industrial applications. Their chemical, thermal, and mechanical resistance, combined with its excellent hydrolytic stability and relatively inexpensive production costs, make it ideal for widespread use in fabrication of membranes, in particular porous hollow-fiber polymeric membranes. Porous hollow-fiber polymeric membranes are employed in many applications such as hemodialysis, ultrafiltration, nanofiltration, reverse osmosis, gas separation, microfiltration, desalination via membrane distillation, and pervaporation. For many of these applications, membranes with optimal selectivity as well as chemical, thermal and mechanical stability are desirable.

While poly(arylether) polymers (PAE) have many advantages, and good physical properties, it is sometimes desirable to tune one or more properties to improve performance in specific applications (for example, hemodialysis, bio-separation or water filtration), such as becoming less susceptible for fouling, having an increased hydrophilic nature and/or having an improved biocompatibility.

The intrinsic hydrophobicity of PAE polymers indeed renders membranes made therefrom prone to fouling which negatively impacts their performance. Fouling is caused by hydrophobic interactions between membrane materials and foulants (e.g., microorganisms, proteins, or organic matter) originating from a fluid to be treated though the membrane. In particular, fouling is initiated by the adsorption of foulants onto the membrane surface and the interior structure, resulting in pore blocking, cake layer formation, or biofilm formation. Membrane fouling not only decreases membrane permeability and overall lifetime, but also increases maintenance costs due to extensive and frequent cleaning to remove foulants.

Since most of the commercial pressure driven membranes are made of hydrophobic polymers including polyethersulfone (PES), polysulfone (PSU) and poly (ether ether ketone) (PEEK), enhancing surface hydrophilicity can be achieved by increasing the density of the hydrophilic groups at the membrane surface, as hydrophilic modification ofmembrane surfaces reduces organic fouling propensity.

For example the PAE may be blended with a highly hydrophilic polymer such as polyvinylpyrolidone to increase the hydrophilicity of a PAE-based membrane, while the PAE can be blended with a zwiterrionic polymer in order to impart antifouling properties. Even though this approach may be straightforward, there are serious limitations as typically the two or more polymers which are blended are not compatible which results in gross macro-phase separation in the final product.

Further since these polymers are simply physical mixtures, the resultant product may change its composition and thus its performance due to the loss of one of polymer due to diffusion during operation of the membrane.

Another approach to avoid such behavior is to covalently link a PAE homopolymer and the other polymer so that the resulting material has a robust composition and does not substantially change during the application.

Modification of hydrophilicity may be also achieved by combining two homopolymers to make block copolymers that possess the combination of intrinsic properties of each individual homopolymer. For example, in membrane applications, a PAES homopolymer can be covalently linked to a hydrophilic homopolymer to synthesize a new PAES-hydrophilic block copolymer possessing superior membrane performance owing to the enhanced wettability caused by the hydrophilic component while retaining the mechanically robust and amorphous pore structure of the PAES component. In this technique due to the inherent low molecular weight of the PAES component, the mechanical performance of the final product may get compromised.

Another technique reported in the literature involves covalent grafting as a means to modify the polyarylether polymers' properties. Graft copolymerization is a reaction in which side chain grafts, originated from one or more vinyl monomers, are covalently attached to a linear polymer backbone leading to formation of graft copolymers, that have new characteristics, originated from two or more parent polymers. The grafting may involve polymerization reaction between a base polymer with functional groups with the vinyl monomers and involves formation of reactive groups on the base polymer. In terms of fouling prevention, the large chain density of the grafted polymer closes the gap between polymer chains, making such gaps much smaller than the size of the proteins and/or microbial cells. This causes difficulty for their adsorption on the membrane surface through the membrane's voids.

Yang et al, “Cross-linked poly (aryl ether ketone) anion exchange membrane with high ion conductivity by two different functional imidazole side chain”, in Reactive and Functional Polymers, Vol. 151, 104551 (June 2020) and Xu et al, “A facile functionalized routine for the synthesis of side-chain sulfonated poly(arylene ether ketone sulfone) as proton exchange membranes” International Journal of Hydrogen Energy, Vol, 42(8), pages 5295-5305 (February 2017) report the covalent attachment of a vinyl monomer onto a polyarylether ketone and ketone sulfone polymers which have side-chain allyl groups. In these examples, very short chains consisting of monomer or dimers are attached to the polymer via free radical grafting.

KR20170115697A relates to an osmotic membrane which includes a support formed by the reaction of a functionalized polysulfone-based polymer “APSf” with a hydrophilic compound to have hydrophilicity and thereby to have improved water permeability. The APSf polymer has a double bond in side chains and is a homopolymer made by polymerization of 2,2′-diallyl bisphenol A and difluorodiphenylsulfone with potassium carbonate. However no solvent is disclosed in this reference to make the APSf, and the APSf homopolymer is not characterized such in molecular weight and glass transition temperature. The hydrophilic compound has a double bond that reacts with the side-chain double bonds of the APSf polymer. These double bonds may be activated by radical initiators. In the examples, the APSf homopolymer (1 g) was mixed with a traditional polysulfone “PSf” (1 g) and treated with a vinyl monomer (0.8 g of N, N-dimethylaminoethyl methacrylate) in the presence of a radical initiator (0.1 g of azobisisobutyronitrile) in 7 g of N-methylpyrrolidone “NMP”, and reacted for 3 hours at 60° C. At the end of the radical reaction, the mixture is used ‘as is’ to apply to non-woven fabric of polyethylene terephthalate attached to a glass plate. However in this reference, the resulting PSf-based polymers are not isolated from ungrafted vinyl polymer, unreacted monomers and radical initiator. Moreover the APSf homopolymer would be very hydrophobic since it contains two allyl groups in every repeating unit and this type of homopolymer would be difficult to make in polar aprotic solvents such as dimethylsulfoxide, NMP.

### SUMMARY OF INVENTION

The present invention provides an amorphous graft polyarylether [hereinafter “PAE” ] copolymer (P1) and a process for preparing such copolymer (P1). An amorphous side-chain allyl/vinylene-functionalized polyarylether copolymer (P0) is grafted with functional vinyl monomers to result in the graft copolymer (P1) in which a vinyl polymer is covalently attached to the some of the side chains of the polyarylether copolymer backbone. This graft polyarylether copolymer (P1) encompasses the advantages of both the polyarylether polymer and the vinyl polymer for specific applications. This graft polyarylether copolymer (P1) includes a complex polymer architecture useful in many different applications, for instance to prepare membranes.

The present invention provides a way to introduce functionality in PAE polymers by way of a grafted vinyl polymer from reactive side chains.

A first aspect of the present disclosure is directed to a graft PAE copolymer copolymer (P1) comprising grafted vinyl polymers which are covalently attached to some of the side chains of the PAE copolymer backbone. The copolymer (P1) comprises poly(aryl ether) (PAE) recurring units (R_{P1}), as well as functionalized PAE recurring units (R*_{P1}) with side-chain grafted vinyl polymers, more precisely may comprise poly(arylethersulfone) (‘PAES’) recurring units (R_{P1a}) and PAES recurring units (R*_{P1a}) functionalized with side-chain grafted vinyl polymers, or poly(aryletherketone) (‘PAEK’) recurring units (R_{P1b}) and PAEK recurring units (R*_{P1b}) functionalized with side-chain grafted vinyl polymers.

A second aspect of the present invention is directed to an amorphous side-chain allyl/vinylene-functionalized polyaryletherketone copolymer (P0) comprising collectively at least 50 mol % of PAEK recurring units (R_{P1b}) and PAEK recurring units (R*_{P1b}) functionalized with reactive side chains comprising allyl and/or functional groups comprising carbon-carbon double bonds.

A third aspect of the present invention is directed to a process for manufacturing the graft PAE copolymer (P1) from a side-chain allyl/vinylene-functionalized PAE copolymer (P0) comprising allyl and/or functional groups comprising carbon-carbon double bonds which are reactive and can therefore be used to efficiently modify the copolymer.

A fourth aspect of the present invention is directed to the use of resulting graft PAE copolymer (P1) in various applications, for example to prepare membranes.

A fifth aspect of the present invention is directed to an article comprising the graft PAE copolymer (P1), said article being preferably a membrane or a part thereof.

Another aspect of the present invention is directed to a solution comprising the graft PAE copolymer (P1), particularly used for forming a film, fiber or membrane.

A further aspect of the present invention may be directed to a purification method comprises at least a filtration step through a membrane, fiber or film comprising, or made from, the graft PAE copolymer (P1) described herein.

### Disclosure of Preferred Embodiments of the Present Invention

In the present application:
any description, even though described in relation to a specific embodiment, is applicable to and interchangeable with other embodiments of the present disclosure, and each embodiment thus defined may be combined with another embodiment, unless otherwise indicated or clearly incompatible;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list;
any recitation herein of numerical ranges by endpoints includes all numbers subsumed within the recited ranges as well as the endpoints of the range and equivalents;
the term “comprising” (or “comprise”) includes “consisting essentially of” (or “consist essentially of”) and also “consisting of” (or “consist of”); and
the use of the singular ‘a’ or ‘one’ herein includes the plural unless specifically stated otherwise; and
it should be understood that the elements, properties and/or the characteristics of a (co)polymer, product or article, a process or a use, described in the present specification, may be combined in all possible ways with the other elements, properties and/or characteristics of the (co)polymer, product or article, process or use, explicitly or implicitly, this being done without departing from the scope of the present description.

In the present disclosure, the term “recurring unit” designates the smallest unit of a PAE polymer which is repeating in the chain and which is composed of a condensation of an aromatic diol compound and an aromatic dihalo compound. The term “recurring unit” is synonymous to the terms “repeating unit” and “structural unit”.

As used herein, the term “homopolymer” encompasses a polymer which only has one type of recurring unit.

As used herein, the term “copolymer” encompasses a polymer which may have two or more different types of recurring units.

The term “solvent” is used herein in its usual meaning that, it indicates a substance capable of dissolving another substance (solute) to form a uniformly dispersed mixture at the molecular level. In the case of a polymeric solute it is common practice to refer to a solution of the polymer in a solvent when the resulting mixture is transparent and no phase separation is visible in the system. Phase separation is taken to be the point, often referred to as “cloud point”, at which the solution becomes turbid or cloudy due to the formation of polymer aggregates.

The term “membrane” is used herein in its usual meaning, that is to say it refers to a discrete, generally thin, interface that moderates the permeation of chemical species in contact with it. This interface may be molecularly homogeneous, that is, completely uniform in structure (dense membrane), or it may be chemically or physically heterogeneous, for example containing voids, holes or pores of finite dimensions (porous membrane). A membrane generally has an outer surface and inner surfaces inside pores with which chemical species come in contact.

The weight average molecular weight (M_{w}) and the number average molecular weight (Mₙ) can be estimated by gel-permeation chromatography (GPC) calibrated with polystyrene standards and using a mobile phase. The mobile phase may be selected from any solvent for the copolymers (P0), (P1) described herein, for example solvent S₁ disclosed herein, such methylene chloride, N-Methyl-2-pyrrolidone (NMP), sulfolane or N,N′-dimethylacetamide (DMAc). The M_{w} and Mₙ of PAE copolymer (P1) are preferably measured by GPC Method 1 provided in the Examples. The M_{w} and Mₙ of PAE copolymer (P0) are preferably measured by GPC Method 2 provided in the Examples. The polydispersity index (PDI) is hereby expressed as the ratio of weight average molecular weight (M_{w}) to number average molecular weight (Mₙ).

The glass transition temperature of PAE copolymers (P1) and (P0) may be measured by differential scanning calorimetry (DSC), preferably according to ASTM D3418 or according to the method provided in the Examples.

Should the disclosure of any patents, patent applications, and publications which are incorporated herein by reference conflict with the description of the present application to the extent that it may render a term unclear, the present description shall take precedence.

### Graft PAE Copolymer (P1)

The first aspect of the present invention relates to a graft polyarylether copolymer (P1). This graft PAE copolymer (P1) comprises at least two types of recurring units, one type of recurring unit being functionalized by having side-chain grafted vinyl polymers.

The functional groups of the graft PAE copolymer (P1) are inherent to the PAE copolymer backbone, which result from a step-growth polymerization, in the presence of at least one allyl-substituted diol monomer, to form a side-chain allyl/vinylene-functionalized PAE copolymer (P0) which serves as a basis to make the copolymer (P1). This advantageously makes the PAE copolymer backbone versatile as the content of functionality can be adjusted by varying the content of allyl-substituted diol monomer relative to other diol(s) in the reaction mixture when the base PAE copolymer (P0) is formed. The allyl-substituted monomer comprises two pendant allyl group side chains, each of which comprises from 3 to 7 carbon atoms.

The graft PAE copolymer (P1) of the present invention is in the form of a racemate product. Due to the presence of the base and high temperature during polymerization to form the base PAE copolymer (P0) from which copolymer (P1) is formed, the allyl-substituted monomer usually racemizes during polymerization in such a way that the position of the double bond may change along the side chains. This leads to the formation of molecules differing from each others by the fact that the C═C double bond may be at the end of the side chain or one carbon before the end of the side chain. The amount of racemization depends on the reaction time and temperature.

The copolymer (P1) of the present invention comprises:
collectively at least 50 mol. % of sulfone recurring units (R_{P1a}) of formula (M1) and functionalized sulfone recurring units (R*_{P1a}) of formula (N1), said mol. % being based on the total number of moles of recurring units in the copolymer (P1):

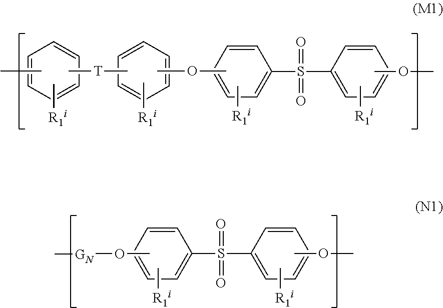

or
collectively at least 50 mol. % of ketone recurring units (R_{P1b}) of formula (M2) and functionalized ketone recurring units (R*_{P1b}) of formula (N2), said mol. % being based on the total number of moles of recurring units in the copolymer (P1):

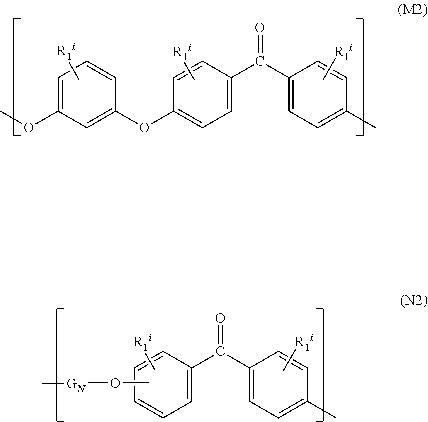

wherein
the molar ratio of recurring units (R_{P1a})/recurring units (R*_{P1a}) or recurring units (R_{P1b})/recurring units (R*_{P1b}) is at least 1/5 and at most 100/1;
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4, preferably i=0 or 1;
T is selected from the group consisting of a bond; —C(CH₃)₂—; —SO₂—; —CH₂—; —O—; —S—; —C(O)—; —C(CF₃)₂—; —C(═CCl₂)—; —C(CH₃)(CH₂CH₂COOH)—; —N═N—; and —RₐC═CR_{b}—, where each Rₐ and R_{b}, independently of one another, is a hydrogen or a C₁-C₁₂-alkyl, C₁-C₁₂-alkoxy, or C₆-C₁₈-aryl group; —(CH₂)ₘ— and —(CF₂)ₘ— with m being an integer from 1 to 6; an aliphatic divalent group, linear or branched, of up to 6 carbon atoms; and combinations thereof; preferably T being selected from the group consisting of a bond, —C(CH₃)₂— and —SO₂—;
G_{N} is selected from the group consisting of the following formulae (G_{N1}) to (G_{N10}) and any combination thereof:

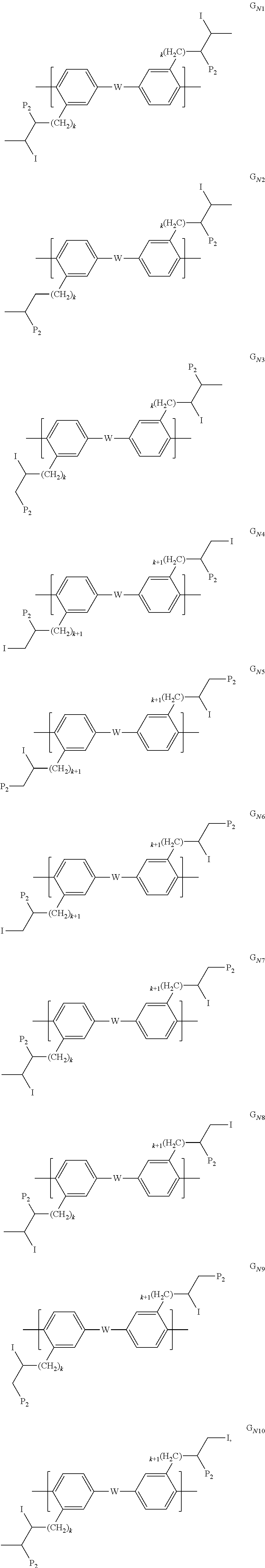

wherein
W in the group G_{N} is selected from the group consisting of a bond, —SO₂—, —C(CH₃)₂— and any combination thereof, preferably selected from —C(CH₃)₂— and/or —SO₂— or selected from —C(CH₃)₂— and/or a bond;
each k in the group G_{N} is independently 0 or an integer from 1 to 4, preferably k=0, 1, 2, or 3, more preferably k=0;
the two grafted polymers P₂ in the group G_{N}, being the same or different from each other, are grafted poly(vinylpyrrolidone) polymers (‘PVP’); and
the two I in the group G_{N}, being the same or different from each other, represent a fragment of a free radical initiator and/or a fragment of a PVP polymer.

The graft PAE copolymer (P1) of the present invention excludes a homopolymer consisting of only functionalized sulfone recurring units (R*_{P1a}) of formula (N1) or consisting of only functionalized ketone recurring units (R*_{P1b}) of formula (N2′).

The molar ratio of recurring units (R_{P1a})/recurring units (R*_{P1a}) or of recurring units (R_{P1b})/recurring units (R*_{P1b}) may be at least 1/5, at least 1/4, at least 1/3, at least 1/2, or at least 1/1, and/or at most 100/1, at most 50/1, at most 25/1, or at most 22/1. The molar ratio of recurring units (R_{P1a})/recurring units (R*_{P1a}) or of recurring units (R_{P1b})/recurring units (R*_{P1b}) in the PAE copolymer (P1) may be from 1/4 to 50/1, preferably from 1/3 to 40/1 or from 1/3 to 30/1, more preferably from 1/2 to 30/1, from 1/2 to 25/1, or from 1/2 to 22/1.

The graft PAE copolymer (P1) may be such that each R₁ is independently selected from the group consisting of a C₁-C₁₂ moiety optionally comprising one or more than one heteroatoms; sulfonic acid and sulfonate groups; phosphonic acid and phosphonate groups; amine and quaternary ammonium groups.

The graft PAE copolymer (P1) preferably may be such that i is zero for each R₁ (meaning that no phenyl rings are substituted).

In other embodiments, the graft PAE copolymer (P1) having sulfone recurring units of formulae (M1) and (N1) may be such that in some recurring units of formulae (M1) and (N1), some R₁ are selected from sulfonic acid groups; alkali or alkaline earth metal sulfonate groups; and/or alkyl sulfonate groups, with its corresponding i being 1, while in other sulfone recurring units of formulae (M1) and (N1), i=0 (i.e., the phenyl rings are not substituted). A phenyl ring which is optionally substituted with such R₁ and i=1 is preferably connected to a —SO₂— linking group of the sulfone recurring units.

Alternatively, the graft PAE copolymer (P1) having ketone recurring units of formulae (M2) and (N2) may be such that in some ketone recurring units of formulae (M2) and (N2), some R₁ are selected from sulfonic acid groups; alkali or alkaline earth metal sulfonate groups; and/or alkyl sulfonate groups, with its corresponding i being 1, while in other ketone recurring units of formulae (M2) and (N2), i=0 (i.e., the phenyl rings are not substituted). A phenyl ring which is optionally substituted with such R₁ and i=1 is preferably connected to a —C(O)— linking group of the ketone recurring units.

The graft PAE copolymer (P1) may be such that in the group G_{N} of any of the formulae (G_{N1}) to (G_{N10}), k is zero.

In some embodiments, the graft PAE copolymer (P1) may be such that in group G_{N} of any of the formulae (G_{N1}) to (G_{N10}), W may be —C(CH₃)₂— and/or —SO₂—. In a same graft PAE copolymer (P1), W may be —C(CH₃)₂— in some groups G_{N} while W may be —SO₂— in other groups G_{N}. Preferably however in a same graft PAE copolymer (P1), W is the same in all groups G_{N} and is either —C(CH₃)₂— or —SO₂—.

In other embodiments related to a graft PAEK copolymer (P1) having ketone recurring units of formulae (M2) and (N2), W in the group G_{N} of any of the formulae (G_{N1}) to (G_{N10}) may be a bond and/or —C(CH₃)₂—. In a same graft PAEK copolymer (P1), W may be —C(CH₃)₂— in some groups G_{N} while W may be a bond in other groups G_{N}. Preferably however in a same graft PAEK copolymer (P1), W is the same in all groups G_{N} and is either —C(CH₃)₂— or a bond.

Each of the grafted polymers P₂ in the group G_{N} of any of the formulae (G_{N1}) to (G_{N10}) in recurring units (R*_{P1a}) or (R*_{P1b}) may comprise at least 50 mol. %, based on the total number of moles of recurring units in the grafted polymer P₂, of recurring units Rp of formula (P):

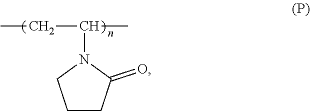

in which n in formula (P) is an integer of at least 3, or at least 5, or at least 8, or at least 10, or at least 20, or at least 30, or at least 40, or at least 50, and at most 200, or at most 175, or at most 150, or at most 100. In the recurring units Rp of formula (P), n is preferably from 3 to 200, or from 10 to 200, or from 10 to 150, or from 50 to 150, or from 50 to 100, or from 60 to 90, or from 65 to 85.

Each of the grafted polymers P₂ in the group G_{N} of any of the formulae (G_{N1}) to (G_{N10}) may comprise collectively at least 55 mol. %, at least 60 mol. %, at least 70 mol. %, at least 80 mol. %, at least 90 mol. %, at least 95 mol. %, at least 99 mol. % of the recurring units Rp of formula (P) based on the total number of moles of recurring units in the grafted polymer P₂. Each of the grafted polymer P₂ in the group G_{N} of any of the formulae (G_{N1}) to (G_{N10}) may preferably consist essentially of the recurring units Rp of formula (P).

The graft PAE copolymer (P1) may be such that I in the group G_{N} may be a fragment of a free radical initiator selected from the group consisting of 2,2′-Azobis(2-methylpropionitrile) (AIBN), 2,2′-azobis(2,4-dimethylvaleronitrile) (ADVN), benzoyl peroxide, hydroperoxides and any combination thereof, and/or may be a fragment of a PVP polymer chain which comprises at least 50 mol. %, at least 55 mol. %, at least 60 mol. %, at least 70 mol. %, at least 80 mol. %, at least 90 mol. %, at least 95 mol. %, at least 99 mol. % of the recurring units Rp of formula (P), based on the total number of moles of recurring units in said I. When at least one of the I in a group G_{N} is a fragment of a PVP polymer chain, the chain length or molecular weight (Mₙ) of I is preferably less than the chain length or molecular weight (Mₙ) of the two grafted polymers P₂ in the same group G_{N}.

Preferably, when at least one of the two I in the group G_{N} is a fragment of a free radical initiator, such an I may be a fragment of AIBN, such as

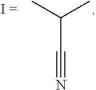

When at least one of the two I in the group G_{N} is a fragment of a PVP polymer chain, such an I preferably consists essentially of recurring units Rp of formula (P).

The graft PAE copolymer (P1) is preferably made by free radical polymerization of a side-chain allyl/vinylene-functionalized polyarylether copolymer (P0) comprising side-chain carbon-carbon double bonds and which does not contain bound PVP, with a vinyl pyrrolidone monomer and a free radical initiator.

The graft PAE copolymer (P1) is preferably not crosslinked. During the making of the copolymer (P1) from the copolymer (P0), there is indeed no observable crosslinking that occurs within the PAE copolymer or within the vinyl polymer or between them, as indicated by the resulting very good solubility of the copolymer (P1) without the presence of any gel or undissolved masses and a glass transition temperature of copolymer (P1) which is similar (within +/−15° C., preferably within +/−11° C., more preferably within +/−10° C. or within +/−8%, or within +/−6%, or within +/−5%) to the glass transition temperature of the copolymer (P0) from which the copolymer (P1) is made. The Tg and Tg⁰ are preferably measured by differential scanning calorimetry (DSC), preferably according to ASTM D3418 or according to the method provided in the Examples.

In alternate embodiments, the graft PAE copolymer (P1) may have a glass transition temperature Tg which is from Tg⁰−10° C. to Tg⁰+10° C., wherein Tg⁰ is the glass transition temperature of the side-chain allyl/vinylene-functionalized PAE copolymer (P0) from which the copolymer (P1) is made. The Tg and Tg⁰ are preferably measured by differential scanning calorimetry (DSC), preferably according to ASTM D3418 or according to the method provided in the Examples.

The graft PAE copolymer (P1) preferably contains less than 2 wt %, preferably less than 1 wt %, more preferably less than 0.5 wt %, yet more preferably less than 0.3 wt % or less than 0.1 wt %, of free vinyl pyrrolidone, based on the total weight of the graft PAE polymer (P1). The detection of free vinyl pyrrolidone may be done via Fourier transform infrared spectroscopy (FTIR).

The graft PAE copolymer (P1) preferably contains less than 2 wt %, preferably less than 1 wt %, more preferably less than 0.5 wt %, yet more preferably less than 0.3 wt % or less than 0.1 wt %, of free poly(vinyl pyrrolidone), based on the total weight of the graft PAE polymer (P1). The detection of free PVP may be done via Fourier transform infrared spectroscopy (FTIR).

The graft PAE copolymer (P1) has the same polymeric main chain as the base PAE copolymer (P0) from which the copolymer (P1) is made. The difference between the graft PAE copolymer (P1) and the side-chain allyl/vinylene-functionalized PAE copolymer (P0) is the presence of the grafted polymers P₂ grafted on some side chains of the copolymer (P1), which are attached by way of reaction with the side-chain allyl/vinylene groups in its corresponding PAE copolymer (P0).

The graft PAE copolymer (P1) has a weight average molecular weight M_{w} of at least 150 kDa, preferably at least 200 kDa, more preferably at least 250 kDa or at least 300 kDa. The graft PAE copolymer (P1) has a weight average molecular weight M_{w} of at most 1100 kDa, preferably at most 1000 kDa, more preferably at most 900 kDa or at most 700 kDa. The graft PAE copolymer (P1) may have a weight average molecular weight M_{w} of from 200 kDa up to 1100 kDa, preferably from 250 kDa up to 1000 kDa, more preferably from 300 kDa up to 900 kDa, yet more preferably from 300 kDa up to 700 kDa. The M_{w} of the PAE copolymer (P1) are preferably measured by GPC Method 1 provided in the Examples.

The graft PAE copolymer (P1) preferably has a PDI=M_{w}/Mₙ greater than the PDI⁰=M_{w}⁰/Mₙ⁰ of the side-chain allyl/vinylene-functionalized PAE copolymer (P0) from which the graft PAE copolymer (P1) is made. The Mₙ and M_{w} of the PAE copolymer (P1) are preferably measured by GPC Method 1 provided in the Examples, and the Mₙ⁰ and M_{w}⁰ of the PAE copolymer (P0) are preferably measured by GPC Method 2 provided in the Examples. In general, the graft PAE copolymer (P1) may have a PDI of at least 4, or at least 4.5, or at least 5, or at least 5.5, or at least 6, or at least 6.5.

The graft PAE copolymer (P1) may have a glass transition temperature Tg which is within +/−15° C. or within +/−11° C. or within +/−10%, preferably within +/−8%, more preferably within +/−6%, yet more preferably within +/−5%, of the glass transition temperature Tg⁰ of the side-chain allyl/vinylene-functionalized PAE copolymer (P0) from which the graft PAE copolymer (P1) is made. The Tg and Tg⁰ are preferably measured by differential scanning calorimetry (DSC), preferably according to ASTM D3418 or according to the method provided in the Examples.

In alternate embodiments, the graft PAE copolymer (P1) may have a glass transition temperature Tg which is from Tg⁰−10° C. to Tg⁰+10° C., wherein Tg⁰ is the glass transition temperature of the side-chain allyl/vinylene-functionalized PAE copolymer (P0) from which the copolymer (P1) is made. The Tg and Tg⁰ are preferably measured by differential scanning calorimetry (DSC), preferably according to ASTM D3418 or according to the method provided in the Examples.

The solubility of the graft PAE copolymer (P1) in a particular solvent is the same or higher than the solubility the side-chain allyl/vinylene-functionalized PAE copolymer (P0) from which the copolymer (P1) is made. Preferred solvents into which the graft PAE copolymer (P1) is soluble is 1,3-dimethyl-2-imidazolidinone (DMI), dimethylsulfoxide (DMSO), DMAc, tetramethylene sulfone (sulfolane), NMP, or any mixture thereof.

### Graft PAES Copolymer (P1)

When the graft PAE copolymer (P1) comprises recurring units (R_{P1a}) and functionalized recurring units (R*_{P1a}), it may be referred to as a graft “PAES” copolymer (P1).

The graft PAES copolymer (P1) preferably has a Tg ranging from 140 and 250° C., preferably from 170 and 240° C., more preferably from 180 and 220° C., as measured by differential scanning calorimetry (DSC), preferably according to ASTM D3418 or according to the method provided in the Examples.

The graft PAES copolymer (P1) may comprise collectively at least 55 mol. %, at least 60 mol. %, at least 70 mol. %, at least 80 mol. %, at least 90 mol. %, at least 95 mol. %, at least 99 mol. % of recurring units (R_{P1a}) and (R*_{P1a}), based on the total number of moles in the graft PAES copolymer (P1). The graft PAES copolymer (P1) may preferably consist essentially of recurring units (R_{P1a}) and (R*_{P1a}).

The molar ratio of recurring units (R_{P1a})/recurring units (R*_{P1a}) in the graft PAES copolymer (P1) may be:
at least 1/4, at least 1/3, at least 1/2, at least 1/1, and/or
at most 50/1, at most 40/1, at most 30/1, at most 25/1, or at most 22/1.

The molar ratio of recurring units (R_{P1a})/recurring units (R*_{P1a}) in the graft PAES copolymer (P1) may be from 1/4 to 50/1, preferably from 1/3 to 40/1, more preferably from 1/2 to 30/1 or from 1/3 to 30/1, from 1/2 to 25/1, from 1/2 to 22/1, or from 1/1 to 22/1.

The graft PAES copolymer (P1) may be such that in recurring units (R_{P1a}), T is selected from the group consisting of a bond, —SO₂—, —C(CH₃)₂— and any combination thereof. The graft PAES copolymer (P1) may, for example, comprise some recurring units (R_{P1a}) in which T is —C(CH₃)₂— and other recurring units (R_{P1a}) in which T is —SO₂—.

Preferred recurring units (R_{P1a}) in the graft PAES copolymer (P1) may be of formula (M1a), (M1b), or (M1c):

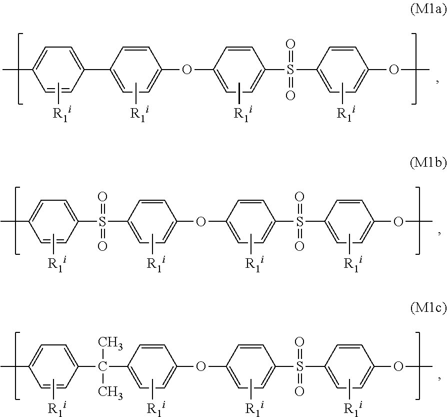

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each i is independently 0 or an integer from 1 to 4, preferably i=0.

More preferred recurring units (R_{P1a}) in the graft PAES copolymer (P1) may be of formula (M1b′) and/or (M1b″):

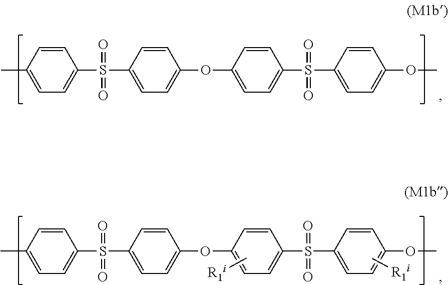

wherein
each R₁ is independently selected from the group consisting of alkali or alkaline
earth metal sulfonate and alkyl sulfonate; and
each i is independently an integer of 1 to 4, preferably i=1.

### Amorphous Graft PAEK Copolymer (P1)

When the graft PAE copolymer (P1) comprises recurring units (R_{P1b}) and functionalized recurring units (R*_{P1b}), it may be referred to as a graft “PAEK” copolymer (P1).

The graft PAEK copolymer (P1) preferably has a Tg ranging from 100 to 200° C., preferably from 105 to 150° C., more preferably from 110 to 140° C., as measured by differential scanning calorimetry (DSC), preferably according to ASTM D3418 or according to the method provided in the Examples.

The graft “PAEK” copolymer (P1) is an amorphous polymer, meaning that the graft “PAEK” copolymer (P1) does not exhibit a melting point (Tm) identified by differential scanning calorimetry (DSC), preferably according to ASTM D3418 or according to the method provided in the Examples.

The graft PAEK copolymer (P1) may comprise collectively at least 55 mol. %, at least 60 mol. %, at least 70 mol. %, at least 80 mol. %, at least 90 mol. %, at least 95 mol. %, or at least 99 mol. % of recurring units (R_{P1b}) and (R*_{P1b}), based on the total number of moles in the graft PAEK copolymer (P1). The graft PAEK copolymer (P1) may preferably consist essentially of recurring units (R_{P1b}) and (R*_{P1b}).

The molar ratio of recurring units (R_{P1b})/recurring units (R*_{P1b}) in the graft PAEK copolymer (P1) may be:
at least 1/4, at least 1/3, at least 1/2, or at least 1/1, and/or
at most 50/1, at most 40/1, at most 30/1, at most 25/1, or at most 22/1.

The molar ratio of recurring units (R_{P1b})/recurring units (R*_{P1b}) in the graft PAEK copolymer (P1) may be from 1/4 to 50/1, preferably from 1/3 to 40/1 or from 1/3 to 30/1, more preferably from 1/2 to 30/1, from 1/2 to 25/1, or from 1/2 to 22/1.

Preferred recurring units (R_{P1b}) in the graft PAEK copolymer (P1) may be of formula (M2a):

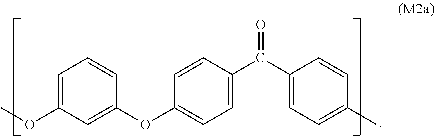

The graft PAEK copolymer (P1) may further comprise one or more other recurring units (R′_{P1b})—different than recurring units (R_{P1b}) and (R*_{P1b}), such as those of the following formula (M2b) or (M2b′):

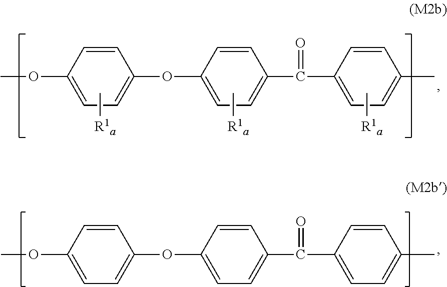

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each i is independently 0 or an integer from 1 to 4.

In such instances, the graft PAEK copolymer (P1) may comprise at most 20 mol. %, at most 15 mol. %, or at most 10 mol. % of recurring units (R′_{P1b}), based on the total number of moles in the graft PAEK copolymer (P1). The amount of recurring units (R′_{P1b}) in the graft PAEK copolymer (P1) should be such that the graft PAEK copolymer (P1) retains its amorphous state making it soluble in polar aprotic solvents like NMP, sulfolane, DMAc, and others described herein.

### Process for Preparing the Graft PAE Copolymer (P1)

The graft PAE copolymer (P1) can be formed via free radical reaction with a vinyl pyrrolidone monomer in presence of a free radical initiator.

The second aspect of the present invention thus relates to a process for preparing the graft PAE copolymer (P1) comprising:
reacting, in a solvent S₁, a side-chain allyl/vinylidene-functionalized polyarylether copolymer (P0) with vinyl pyrrolidone monomer in the presence of at least one free radical initiator, to form the graft polyarylether copolymer (P1); and
removing any free poly(vinyl pyrrolidone) and optionally any unreacted vinyl pyrrolidone monomer and/or unreacted free radical initiator from the formed graft PAE copolymer (P1) to generate a purified the graft PAE copolymer (P1).

The side-chain allyl/vinylene-functionalized PAE copolymer (P0) comprises
sulfone-based recurring units (R_{P0a}) and functionalized recurring units (R*_{P0a}) which are defined later; or
ketone-based recurring units (R_{P0b}) and functionalized recurring units (R*_{P0b}) which are defined later.

While the number of moles of functionalized recurring units (R*_{P0a}) or (R*_{P0b}) in the PAE copolymer (P0) used in the reaction mixture is n₁; and the number of moles of vinyl pyrrolidone monomer used in the reaction mixture is n₂, the molar ratio n₂/n₁ is at least 3, or at least 5, or at least 8, or at least 10, or at least 20, or at least 30, or at least 40, or at least 50, and at most 200, or at most 175, or at most 150, or at most 100. The molar ratio n₂/n₁ is preferably from 3 to 200, or from 10 to 200, or from 10 to 150, or from 50 to 150, or from 50 to 100, or from 60 to 90, or from 65 to 85.

The reacting step is preferably carried out in a reaction mixture comprising the vinyl pyrrolidone monomer and the solvent S₁. The free radical initiator may be added to the reaction mixture to initiate the reaction.

For the reacting step, the copolymer (P0) and the vinyl pyrrolidone monomer may be first added to a reactor vessel and then dissolved into the solvent S₁ and heated at a suitable reaction temperature.

Alternatively, the copolymer (P0) may be first shaped into an article and then contacted with the reaction mixture comprising the vinyl pyrrolidone monomer, the free radical initiator and the solvent S₁ and heated at a suitable reaction temperature.

The reaction mixture is preferably purged with a non-oxidizing gas or atmosphere (such as nitrogen) before the free radical initiator is added to start the free radical reaction. The time period for the purge may vary from 10 to 120 minutes, while 20 to 60 minutes generally suffice.

The free radical reaction may generally take place for at least 1 hour and at most 48 hours, preferably for at least 3 hour and at most 24 hours, more preferably for at least 6 hour and at most 18 hours, yet more preferably for at least 8 hour and at most 16 hours.

The reacting step to prepare the graft PAE copolymer (P1) may be carried out under at least one of the following reaction conditions i) to iv):
i) in the presence of a solvent;
ii) in the presence of at least one free radical initiator;
iii) at a reaction temperature from 10° C. to 200° C.;
iv) in the absence of crosslinking conditions.

Reaction condition (i): when the reaction to prepare the graft PAE copolymer (P1) is carried out in a solvent S₁, the solvent S₁ is a polar aprotic solvent selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof; preferably selected from the group consisting of 1,3-dimethyl-2-imidazolidinone (DMI), N-Methyl-2-pyrrolidone (NMP), dimethylsulfoxide (DMSO), dimethylsulfone (DMSO2), N-butylpyrrolidinone (NBP), N-Ethylpyrrolidone (NEP), N,N′-dimethylacetamide (DMAc), N,N′-dimethylpropyleneurea (DMPU), dimethylformamide (DMF), sulfolane, and mixtures thereof. The polar aprotic solvent S₁ is preferably selected from the group consisting of N-methylpyrrolidone (NMP), N-butylpyrrolidone (NBP), N-ethyl-2-pyrrolidone, N,N-dimethylformamide (DMF), N,N dimethylacetamide (DMAC), 1,3-dimethyl-2-imidazolidinone, tetrahydrofuran (THF), dimethyl sulfoxide (DMSO), sulfolane, and mixtures thereof. The solvent S₁ may also include chloroform or dichloromethane (DCM). The reaction to prepare the graft PAE copolymer (P1) is more preferably carried out in sulfolane, DMAc, DMI, DMSO, and/or NMP.

The solvent S₁ used to prepare the graft PAE copolymer (P1) may be the same as the solvent S₀ used to prepare the copolymer (P0).

The solvent S₁ used to prepare the copolymer (P1) may be different than the solvent S₀ used to prepare the copolymer (P0). For example the solvent S₁ used to prepare the copolymer (P1) may include or be NMP and the solvent S₀ used to prepare the copolymer (P0) may include or be sulfolane, DMSO, DMI, or DMAc, or vice versa.

Reaction condition (ii): the at least one free radical initiator is a thermal initiator that may be a phenyl free radical initiator and/or an isobutyronitrile or isoheptilnitrile free radical initiator capable of initiating the polymerization of the vinyl monomer. The free radical initiator may be selected from the group consisting of 2,2′-Azobis(2-methylpropionitrile) (AIBN), 2,2′-azobis(2,4-dimethylvaleronitrile) (ADVN), benzoyl peroxide, hydroperoxides and any combination thereof. The at least one free radical initiator is preferably AIBN or ADVN, more preferably AIBN. As an example, when AIBN is used as free radical initiator, AIBN decomposes partly because of the strong N—N triple bond that is formed, and partly because of the relatively stable radical that results:

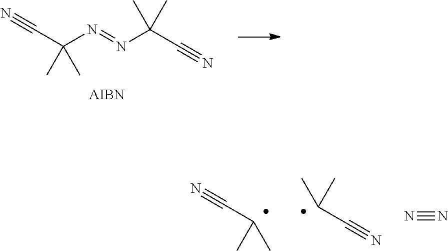

Typically, about 0.1 to 1% by weight of the free radical initiator (e.g., AIBN) based on the weight of the vinyl monomer are used. Generally a higher amount of free radical initiator (e.g., AIBN) with respect to the vinyl monomer weight will decrease the molecular weight of the resulting PVP polymer P₂. Hence, up to 10% by weight of free radical initiator (e.g., AIBN) may be used to make short polymer chains of PVP polymer P₂.

It is preferred to use the free radical initiator all at once to initiate the reaction. However the free radical initiator can also be gradually fed to the reaction system if needed.

Reaction condition (iii): the temperature of the reaction to prepare the graft PAE copolymer (P1) varies preferably from room temperature to 150° C., or more preferably from 35° C. to 100° C., yet more preferably from 50° C. to 80° C.

Reaction condition (iv): “Crosslinking” in the context of the reaction condition (iv) means crosslinking between different molecules of PAE copolymers (P1) and/or (P0), between different molecules of vinyl polymers P₂ and/or between molecules of PAE copolymer and molecules of vinyl polymer P₂. The absence of crosslinking conditions preferably includes the absence of a crosslinking agent, the absence of use of radiation during reaction and/or the absence of radiation initiator.

To avoid crosslinking during the reaction, the reaction is preferably carried out in the absence of a crosslinking agent, such as multi-functional vinyl compounds containing at least 2 C═C double bonds. The reaction may, alternatively or additionally, exclude the use of high energy radiation such as γ-rays and electron beam or low energy radiation such as UV and plasma radiation. The reaction preferably excludes the use of any radiation initiator such as a UV radiation initiator.

The amount of the graft PAE copolymer (P1) at the end of the free radical reaction may be at least 10 wt. %, based on the total weight of the graft PAE copolymer (P1) and the solvent S₁, for example at least 15 wt. %, at least 20 wt. % or at least 30 wt. %.

At the end of the free radical reaction, the reaction mixture may be cooled to stop the free radical reaction.

After the reaction mixture is cooled, a large portion of the solvent S₁ may be distilled off from the reaction mixture under subatmospheric pressure. For example, at least 50% by weight, preferably at least 60 wt. %, more preferably from 70 wt. % to about 80 wt %, of the solvent S₁ present in the cooled reaction mixture at the end of reaction is removed by distillation.

The graft PAE copolymer (P1) is separated from the other components of the reaction mixture (e.g., free poly(vinyl pyrrolidone), unreacted radical initiator, fragments of radical initiator, unreacted vinyl pyrrolidone) to obtain a purified copolymer (P1). The separation preferably includes a coagulation and one or more washes.

Coagulation can be used to precipitate the graft PAE copolymer (P1) in a non-solvent or poor solvent, thus forming solid particles of graft PAE copolymer (P1) in order to separate it from the other components which remain in solution with the remainder of solvent S₁. The non-solvent or poor solvent may comprise at least 50% by weight, preferably at least 60 wt % ethyl acetate, methyl acetate, acetone, butanone, and/or a C1-C5 alcohol. The non-solvent or poor solvent may consist of ethyl acetate, methyl acetate, acetone, butanone, and/or a C1-C5 alcohol such as methanol, ethanol, n-propanol, isopropanol, butanol.

The precipitate of the graft PAE copolymer (P1) can be subjected to one or more washes with a washing liquid to further remove free (or unbound) PVP and/or unreacted vinyl pyrrolidone monomer and/or free radical initiator. The washing liquid is preferably water and/or a C1-C5 alcohol (e.g., methanol, ethanol, n-propanol, isopropanol). The washing liquid (e.g., water) is preferably at a temperature of at least 50° C., or at least 60° C., or at least 65° C. The washing liquid should be at a temperature not exceeding its boiling point. The washing liquid is preferably at a temperature of at most 90° C., or at most 85° C., or at most 80° C., or at most 75° C. The washing liquid is more preferably water at a temperature of from 60° C. to 80° C., or from 65° C. to 75° C. The presence of free PVP can be monitored by FTIR in the spent washing liquid after each wash, and the washing step repeated until free PVP is no longer detected in the spent washing liquid.

The purified copolymer (P1) can then be dried at a temperature generally from about 50° C. to 120° C., preferably from about 80° C. to 120° C., more preferably at about 90-120° C., yet more preferably at about 90-110° C., preferably under vacuum.

The dried purified graft PAE copolymer (P1) can be used for preparing an article as described herein, such as a fiber, film or membrane.

In an alternate embodiment, the grafting reaction may be carried out as a finishing technique for shaped articles such as films, membranes, sheets and/or fabrics containing the PAE copolymer (P0). In such instance, there may be an initial step of forming an article containing the PAE copolymer (P0). The article may be made essentially of PAE copolymer (P0), or may contain PAE copolymer (P0) and other polymer(s) distinct from PAE copolymer (P0) as described herein. The method may then comprise: contacting the shaped article with a solution of vinyl pyrrolidone monomer and the free radical initiator to allow controlled modification of PAE copolymer (P0) in the shaped article by covalent immobilization of the grafted PVP polymer P₂ to desired levels. After the grafting reaction is completed, the article is subjected to washing to remove free PVP polymer and, if any, unreacted vinyl monomer and/or unreacted free radical initiator. This method embodiment may avoid membrane shaping problems which may occur on the grafted copolymer (P1) and would permit to remove unreacted monomer/radical or unbound PVP from the shaped article which now contains the graft PAE copolymer (P1) comprising grafted PVP polymers P₂.

### Side-Chain Allyl/Vinylene-Functionalized Polyarylether Copolymer (P0)

The side-chain allyl/vinylene-functionalized polyarylether copolymer (P0) comprises two types of recurring units (R_{P0}) and (R*_{P0}), one type being functionalized recurring units (R*_{P0}) having two pendant allyl/vinylene side-chains which are reactive.

The PAE copolymer (P0) comprises:
collectively at least 50 mol. % of sulfone recurring units (R_{P0a}) of formula (M1) and functionalized sulfone recurring units (R*_{P0a}) of formula (N0):

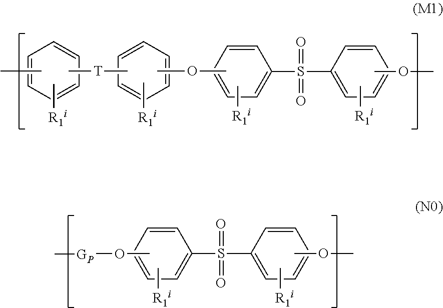

or
collectively at least 50 mol. % of ketone recurring units (R_{P0b}) of formula (M2) and functionalized ketone recurring units (R*_{P0b}) of formula (N0′):

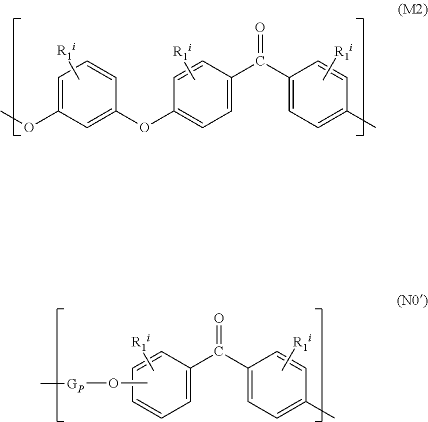

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4, preferably i=0;
T in formula (M1) is selected from the group consisting of a bond; —C(CH₃)₂—; —SO₂—; —CH₂—; —O—; —S—; —C(O)—; —C(CF₃)₂—; —C(═CCl₂)—; —C(CH₃)(CH₂CH₂COOH)—; —N═N—; and —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ— with m being an integer from 1 to 6; an aliphatic divalent group, linear or branched, of up to 6 carbon atoms; and combinations thereof; T preferably being selected from the group consisting of a bond, —C(CH₃)₂— and —SO₂—;
G_{P} is selected from the group consisting of at least one of the following formulae (G_{P1}), (G_{P2}) and (G_{P3}):

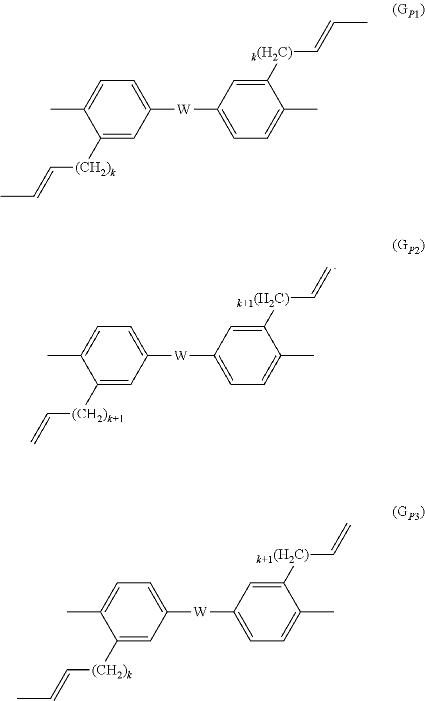

wherein
W in the group G_{P} is selected from the group consisting of a bond, —SO₂—, —C(CH₃)₂— and any combination thereof, preferably selected from —C(CH₃)₂— and/or —SO₂— or selected from —C(CH₃)₂— and/or a bond;
each k in the group G_{P} is independently 0 or an integer from 1 to 4, preferably k=0, 1, 2, or 3, more preferably k=0; and
wherein the molar ratio of sulfone recurring units (R_{P0a})/recurring units (R*_{P0a}) or ketone recurring units (R_{P0b})/recurring units (R*_{P0b}) is at least 1/5 and at most 100/1.

The PAE copolymer (P0) excludes a homopolymer consisting of only functionalized sulfone recurring units (R*_{P0a}) of formula (N0) or consisting of only functionalized ketone recurring units (R*_{P0b}) of formula (N0′).

A particular aspect of the present invention relates to an amorphous PAEK copolymer (P0) comprising collectively at least 50 mol. % of the ketone recurring units (R_{P0b}) of formula (M2) and the functionalized ketone recurring units (R*_{P0b}) of formula (N0′).

The molar ratio of sulfone recurring units (R_{P0a})/recurring units (R*_{P0a}) or ketone recurring units (R_{P0b})/recurring units (R*_{P0b}) may be at least 1/5, at least 1/4, at least 1/3, at least 1/2, or at least 1/1. The molar ratio of sulfone recurring units (R_{P0a})/recurring units (R*_{P0a}) or ketone recurring units (R_{P0b})/recurring units (R*_{P0b}) may be at most 100/1, at most 50/1, at most 30/1, at most 25/1, or at most 22/1. Preferred molar ratio of sulfone recurring units (R_{P0a})/recurring units (R*_{P0a}) or ketone recurring units (R_{P0b})/recurring units (R*_{P0b}) in the PAE copolymer (P0) may be from 1/4 to 50/1, preferably from 1/3 to 40/1 or from 1/3 to 30/1, more preferably from 1/2 to 30/1, from 1/2 to 25/1, from 1/2 to 22/1, or from 1/1 to 22/1.

The PAE copolymer (P0) may be such that k is zero in the group G_{P}.

In some embodiments, a PAES copolymer (P0) having sulfone recurring units of formulae (M1) and (N0) may be such that W in the group G_{P} may be —C(CH₃)₂— and/or —SO₂—. In a same PAES copolymer (P0), W may be —C(CH₃)₂— in some of the groups G_{P}, while W may be —SO₂— in other groups G_{P}. Preferably however in a same PAES copolymer (P0), W is the same in all groups G_{P} and is either —SO₂— or —C(CH₃)₂—.

In other embodiments related to the PAEK copolymer (P0) having ketone recurring units of formulae (M2) and (N0′), W in the group G_{P} of any of the formulae (G_{P1}) to (G_{P3}) is preferably a bond and/or —C(CH₃)₂—. In a same PAEK copolymer (P0), W may be —C(CH₃)₂— in some of the groups G_{P}, while W may be a bond in other groups G_{P}. Preferably however in a same PAEK copolymer (P0), W is the same in all groups G_{P} and is either a bond or —C(CH₃)₂—.

The PAE copolymer (P0) may be such that each R₁ is independently selected from the group consisting of a C1-C12 moiety optionally comprising one or more than one heteroatoms; sulfonic acid and sulfonate groups; phosphonic acid and phosphonate groups; amine and quaternary ammonium groups.

In the PAE copolymer (P0), i is preferably zero for each R₁ (meaning that the phenyl rings are not substituted).

In other embodiments, a PAES copolymer (P0) having sulfone recurring units of formulae (M1) and (N0) may be such that in some sulfone recurring units of formulae (M1) and (N0), some R₁ are selected from sulfonic acid groups; alkali or alkaline earth metal sulfonate groups; and/or alkyl sulfonate groups, with its corresponding i being 1, while in other sulfone recurring units of formulae (M1) and (N0), i=0 (i.e., the phenyl rings are not substituted). A phenyl ring which is optionally substituted with such R₁ and i=1 is preferably connected to a —SO₂-linking group of the sulfone recurring units.

Alternatively, a PAEK copolymer (P0) having ketone recurring units of formulae (M2) and (N0′) may be such that in some ketone recurring units of formulae (M2) and (N0′), some R₁ are selected from sulfonic acid groups; alkali or alkaline earth metal sulfonate groups; and/or alkyl sulfonate groups, with its corresponding i being 1, while in other ketone recurring units of formulae (M2) and (N0′), i=0 (i.e., the phenyl rings are not substituted). A phenyl ring which is optionally substituted with such R₁ and i=1 is preferably connected to a —C(O)— linking group of the ketone recurring units.

The PAE copolymer (P0) has a weight average molecular weight M_{w} of at least 20 kDa, preferably at least 30 kDa or at least 35 kDa, more preferably at least 40 kDa or at least 45 kDa, yet more preferably at least 50 kDa. The copolymer (P0) has a weight average molecular weight M_{w} of at most 200 kDa, preferably at most 180 kDa or at most 160 kDa, more preferably at most 140 kDa or at most 120 kDa, yet more preferably at most 100 kDa. The copolymer (P0) may have a weight average molecular weight M_{w} of from 20 kDa up to 200 kDa, preferably from 30 kDa up to 160 kDa, more preferably from 60 kDa up to 100 kDa. The M, of PAE copolymer (P0) is preferably measured by GPC Method 2 provided in the Examples.

The PAE copolymer (P0) is soluble in a polar aprotic solvent, preferably in the solvent S₁ described herein, more preferably soluble in NMP, DMAc, DMI, DMSO, sulfolane, or mixtures thereof.

### Amorphous PAES Copolymer (P0)

When the PAE copolymer (P0) comprises sulfone-based recurring units (R_{P0a}) and functionalized recurring units (R*_{P0a}), it may be referred to as a “PAES” copolymer (P0).

The PAES copolymer (P0) may have a Tg ranging from 130 and 260° C., preferably from 160 and 250° C., more preferably from 170 and 240° C., as measured by differential scanning calorimetry (DSC), preferably according to ASTM D3418 or according to the method provided in the Examples.

The PAES copolymer (P0) may comprise collectively at least 55 mol. %, at least 60 mol. %, at least 70 mol. %, at least 80 mol. %, at least 90 mol. %, at least 95 mol. %, at least 99 mol. % of recurring units (R_{P0a}) and (R*_{P0a}), based on the total number of moles in the PAES copolymer (P0). The PAES copolymer (P0) may consist essentially of recurring units (R_{P0a}) and (R*_{P0a}).

The molar ratio of recurring units (R_{P0a})/recurring units (R*_{P0a}) in the PAES copolymer (P0) may be:
at least 1/4, at least 1/3, at least 1/2, at least 1/1, and/or
at most 50/1, at most 40/1, at most 30/1, at most 25/1 or at most 22/1.

The molar ratio of recurring units (R_{P0a})/recurring units (R*_{P0a}) in the PAES copolymer (P0) may be from 1/4 to 50/1, preferably from 1/3 to 40/1 or from 1/3 to 30/1, more preferably from 1/2 to 30/1, from 1/2 to 25/1, from 1/2 to 22/1, or from 1/1 to 22/1.

The PAES copolymer (P0) may be such that in recurring units (R_{P0a}), T is selected from the group consisting of a bond, —SO₂—, —C(CH₃)₂— and any combination thereof.

The PAES copolymer (P0) may, for example, comprise some recurring units (R_{P0a}) in which T is —C(CH₃)₂— and other recurring units (R_{P0a}) in which T is —SO₂—.

Preferred recurring units (R_{P0a}) in the PAES copolymer (P0) may be of formula (M1a), (M1b), or (M1c), as shown earlier in relation to recurring units (R_{P1a}), wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each i is independently 0 or an integer from 1 to 4, preferably i=0.

The PAES copolymer (P0) may be such that the recurring units (R_{P0a}) are of the formula (M1b′), shown earlier in relation to recurring units (R_{P1a}).

### Amorphous PAEK Copolymer (P0)

Another aspect of the present invention is a “PAEK” copolymer (P0), when the PAE copolymer (P0) comprises collectively at least 55 mol. %, based on the total number of moles of recurring units in the PAEK copolymer (P0), of ketone-based recurring units (R_{P0b}) of formula (M2) and functionalized ketone-based recurring units (R*_{P0b}) of formula (N0′), as previously described.

The PAEK copolymer (P0) may comprise collectively at least 55 mol. %, at least 60 mol. %, at least 70 mol. %, at least 80 mol. %, at least 90 mol. %, at least 95 mol. %, at least 99 mol. % of recurring units (R_{P0b}) and (R*_{P0b}), based on the total number of moles of recurring units in the copolymer (P0). The PAEK copolymer (P0) may preferably consist essentially of recurring units (R_{P0b}) and (R*_{P0b}).

The PAEK copolymer (P0) is an amorphous polymer, meaning that the PAEK copolymer (P0) does not exhibit a melting point (Tm) identified by differential scanning calorimetry (DSC), preferably according to ASTM D3418 or according to the method provided in the Examples.

The PAEK copolymer (P0) may have a Tg ranging from 90° C. and 200° C., preferably from 95° C. and 160° C., more preferably from 100° C. and 150° C., as measured by differential scanning calorimetry (DSC), preferably according to ASTM D3418 or according to the method provided in the Examples.

The molar ratio of recurring units (R_{P0b})/recurring units (R*_{P0b}) in the PAEK copolymer (P0) may be:
at least 1/4, at least 1/3, at least 1/2, at least 1/1, and/or
at most 50/1, at most 40/1, at most 30/1, at most 25/1, or at most 22/1.

The molar ratio of recurring units (R_{P0b})/recurring units (R*_{P0b}) in the PAEK copolymer (P0) may be from 1/4 to 50/1, preferably from 1/3 to 40/1, more preferably from 1/3 to 30/1, from 1/2 to 30/1, from 1/2 to 25/1, or from 1/2 to 22/1.

Preferred ketone recurring units (R_{P0b}) in the PAEK copolymer (P0) may be of formula (M2a), shown earlier in relation to recurring units (R_{P1b}).

Preferred ketone recurring units (R*_{P0b}) in the PAEK copolymer (P0) are of formula (N0′), in which i is zero for each R₁.

In some embodiments related to the PAEK copolymer (P0) having ketone recurring units of formulae (M2) and (N0′), W in the group G_{P} of any of the formulae (G_{P1}) to (G_{P3}) is preferably a bond and/or —C(CH₃)₂—. In the same PAEK copolymer (P0), W may be —C(CH₃)₂— in some of the groups G_{P}, while W may be a bond in other groups G_{P}. Preferably however in a same PAEK copolymer (P0), W is identical in all groups G_{P} and is either a bond or —C(CH₃)₂—.

The PAEK copolymer (P0) may further comprise other recurring units (R′_{P0b}) such as those of the following formula (M2b) or (M2b′) shown earlier in relation to recurring units (R′_{P1b}). In such instances, the PAEK copolymer (P0) may comprise at most 20 mol. %, at most 15 mol. %, or at most 10 mol. % of recurring units (R′_{P0b}), based on the total number of moles in the PAEK copolymer (P0). The amount of recurring units (R′_{P0b}) in the PAEK copolymer (P0) should be such that the PAEK copolymer (P0) retains its amorphous state.

### Process for Preparing the Side-Chain Allyl/Vinylene-Functionalized PAE Copolymer (P0)

The allyl/vinylene-functionalized PAE copolymer (P0) can be prepared by condensation of at least one aromatic dihydroxy monomer (a1), with at least one aromatic sulfone or ketone monomer (a2) comprising at least two halogen substituents and at least one allyl-substituted aromatic dihydroxy monomer (a3). The reaction mixture preferably comprises at least monomers (a1), (a2) and (a3). When the aromatic monomer (a2) is a dihalo sulfone monomer, the PAE copolymer (P0) may be called “PAES” copolymer (P0). When the aromatic monomer (a2) is a dihalo ketone monomer, the PAE copolymer (P0) may be called “PAEK” copolymer (P0).

The condensation to prepare the copolymer (P0) is preferably carried out in a reaction mixture comprising the monomers (a1), (a2) and (a3) and at least one solvent S₀. The solvent S₀ is for example a polar aprotic solvent selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1, 1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof. The polar aprotic solvent S₀ is preferably selected from the group consisting of N-methylpyrrolidone (NMP), N-butylpyrrolidone (NBP), N-ethyl-2-pyrrolidone, N,N-dimethylformamide (DMF), N,N dimethylacetamide (DMAc), 1,3-dimethyl-2-imidazolidinone, tetrahydrofuran (THF), dimethyl sulfoxide (DMSO), sulfolane, and mixtures thereof. The solvent S₀ may also include chloroform or dichloromethane (DCM). The reaction to prepare the PAE copolymer (P0) is more preferably carried out in sulfolane, DMI, DMSO, DMAc and/or NMP.

The condensation to prepare the PAE copolymer (P0) may be carried out in the presence of at least one base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base acts to deprotonate the components (a1) and (a3) during the condensation reaction.

The condensation to prepare the PAE copolymer (P0) may be carried out with a molar ratio [(a1)+(a3)]/(a2) from 0.9 to 1.1, for example from 0.92 to 1.08 or from 0.95 to 1.05.

The monomer (a3) comprises at least 50 wt. %, based on the total weight of the monomer (a3), or consists of, of a 2,2′-diallyl diol “G_{M}” selected from the group consisting of any of following formulae (G_{M1}), (G_{M2}) and (G_{M3}):

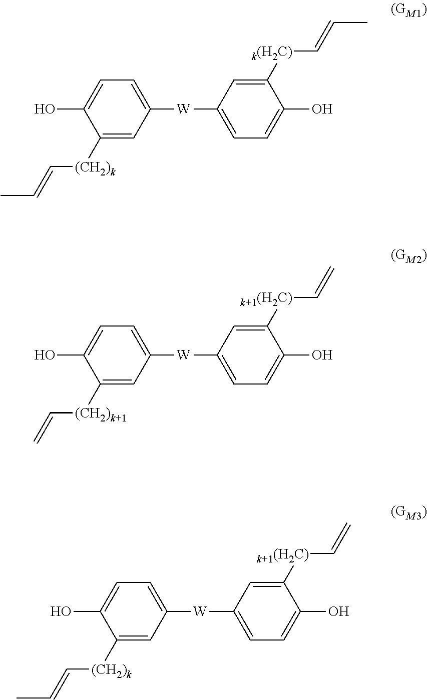

wherein
W in G_{M} is selected from the group consisting of a bond, —C(CH₃)₂—, —SO₂—, and any combination thereof, preferably selected from —C(CH₃)₂— and/or —SO₂— or selected from —C(CH₃)₂— and/or a bond; and each k in G_{M} is independently 0 or an integer from 1 to 4, preferably k=0, 1, 2, or 3, more preferably k=0.

The monomer (a3) preferably comprises at least 50 wt. % of, based on the total weight of the monomer (a3), or consists of, the following 2,2′-diallyl diol of formula (G_{M4})

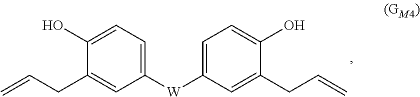

wherein W in formula (G_{M4}) is a bond, —C(CH₃)₂— or —SO₂—, meaning that G_{M4} is 2,2′-diallyl biphenol (daBP), 2,2′-diallyl bisphenol A (daBPA), or 2,2′-diallyl bisphenol S (daBPS). In preferred embodiments, W in formula (G_{M4}) may be —C(CH₃)₂— or —SO₂—, meaning that G_{M4} is daBPA or daBPS. In yet alternate preferred embodiments, W in formula (G_{M4}) may be —C(CH₃)₂— or a bond, meaning that G_{M4} is daBPA or daBP.

The monomer (a3) may for example comprise, based on the total weight of the monomer (a3), at least 60 wt. %, at least 70 wt. %, at least 80 wt. %, at least 90 wt. %, at least 95 wt. %, or at least 99 wt. % of a 2,2′-diallyl diol G_{M} of any of formulae (G_{M1}), (G_{M2}), (G_{M3}) and (G_{M4}). In preferred embodiments, the monomer (a3) comprises, based on the total weight of the monomer (a3), at least 60 wt. %, at least 70 wt. %, at least 80 wt. %, at least 90 wt. %, at least 95 wt. %, or at least 99 wt. % of daBP, or of daBPA or of daBPS.

For preparing the PAES copolymer (P0), the monomer (a1) comprises, based on the total weight of the monomer (a1), at least 50 wt. % of at least one diol selected from the group consisting of: 4,4′ dihydroxybiphenyl (biphenol), 2,2-bis(4-hydroxyphenyl)propane (bisphenol A), 4, 4′ dihydroxydiphenyl sulfone (bisphenol S) and any combination thereof. The monomer (a1) may for example comprise, based on the total weight of the monomer (a1), at least 60 wt. %, at least 70 wt. %, at least 80 wt. %, at least 90 wt. %, at least 95 wt. %, or at least 99 wt. % of at least one diol selected from 4,4′-biphenol, bisphenol A or bisphenol S. The monomer (a1) preferably consists essentially of at least one diol selected from 4,4′-biphenol, bisphenol A or bisphenol S.

For preparing the PAES copolymer (P0), the monomer (a2) comprises at least 50 wt. %, at least 60 wt. %, at least 70 wt. %, at least 80 wt. %, at least 90 wt. %, at least 95 wt. %, or at least 99 wt. %, based on the total weight of the monomer (a2), of at least one 4,4-dihalodiphenylsulfone of following formula:

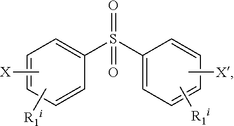

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4, preferably i=0 or 1; and
X and X′ are independently a halogen selected from the group consisting of Cl and F, preferably X and X′ are both Cl.

In some embodiment, at least one R₁ in the 4,4-dihalodiphenylsulfone is selected from the group consisting of alkali or alkaline earth metal sulfonates and alkyl sulfonates, and its corresponding i is equal to 1.

For preparing the PAES copolymer (P0), the monomer (a2) preferably comprises at least 50 wt. %, at least 60 wt. %, at least 70 wt. %, at least 80 wt. %, at least 90 wt. %, at least 95 wt. %, or at least 99 wt. %, based on the total weight of the monomer (a2), of 4,4′-dichlorodiphenyl sulfone (DCDPS), disulfonated 4,4′-dichlorodiphenyl sulfone (sDCDPS), 4,4′ difluorodiphenyl sulfone (DFDPS), or disulfonated 4,4′ difluorodiphenyl sulfone (sDFDPS), more preferably of DCDPS and/or disodium sulfonated DCDPS as follows:

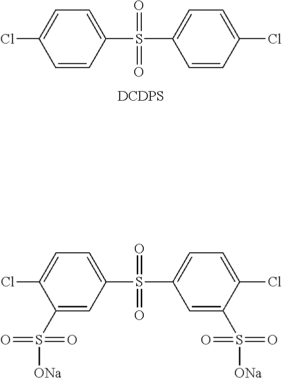

disodium sulfonated DCDPS [disodium bis(4-chloro-3-sulfophenyl)sulfone].

In some embodiments for preparing the PAES copolymer (P0), the monomer (a2) may comprise two or more 4,4-dihalodiphenylsulfones. In particular, the monomer (a2) may comprise at least 50 wt. %, at least 60 wt. %, at least 70 wt. %, at least 80 wt. %, at least 90 wt. %, at least 95 wt. %, or at least 99 wt. %, based on the total weight of the monomer (a2), of two 4,4-dihalodiphenylsulfones of following formula:

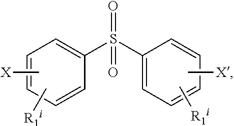

wherein
in one dihalodiphenylsulfone, both X and X′ are Cl or F, preferably X=X′=Cl, and both i equal 0; and
in the other dihalodiphenylsulfone, both X and X′ are Cl or F, preferably X=X′=Cl; both i are 1 and each R₁ may be independently selected from the group consisting of alkali or alkaline earth metal sulfonates and alkyl sulfonates.

Yet in more particular embodiments for preparing the amorphous PAES copolymer (P0), the monomer (a2) may comprise at least 90 wt. % or at least 95 wt. % based on the total weight of the monomer (a2), or may consist essentially, of a mixture of DCDPS and diulfonated DCDPS (sDCDPS). In such instance, the monomer (a2) preferably contains more than 50 mol. %, more than 60 mol. %, more than 70 mol. %, or more than 80 mol. %, of DCDPS, based on the combined number of moles of DCDPS and sDCDPS in the monomer (a2).

For preparing the amorphous PAES copolymer (P0), the monomers (a1), (a2) and (a3) of the reaction mixture are generally reacted concurrently. The reaction is preferably conducted in one stage. This means that the deprotonation of monomers (a1) and (a3) and the condensation reaction between the monomers (a1)+(a3) and (a2) takes place in a single reaction stage without isolation of intermediate products.

For preparing the amorphous PAEK copolymer (P0), the monomer (a1) comprises, based on the total weight of the monomer (a1), at least 50 wt. %, at least 60 wt. %, at least 70 wt. %, at least 80 wt. %, at least 90 wt. %, at least 95 wt. %, or at least 99 wt. %, of the diol of following formula:

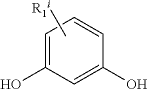

wherein each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and each i is independently 0 or an integer from 1 to 4, preferably i=0 or 1.

The monomer (a1) for preparing the PAEK copolymer (P0) may for example comprise, based on the total weight of the monomer (a1), at least 60 wt. %, at least 70 wt. %, at least 80 wt. %, at least 90 wt. %, at least 95 wt. %, or at least 99 wt. % of resorcinol. The monomer (a1) for preparing the PAEK copolymer (P0) may preferably consist essentially of resorcinol.

For preparing the amorphous PAEK copolymer (P0), the monomer (a2) comprises at least 50 wt. %, at least 60 wt. %, at least 70 wt. %, at least 80 wt. %, at least 90 wt. %, at least 95 wt. %, or at least 99 wt. %, based on the total weight of the monomer (a2), of the difluorodiphenylketone of following formula:

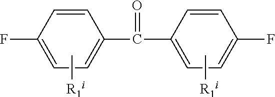

wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4, preferably i=0 or 1.

In some embodiments for preparing the PAEK copolymer (P0), the monomer (a2) may comprise two or more difluoroketones. In particular, the monomer (a2) may comprise at least 50 wt. %, at least 60 wt. %, at least 70 wt. %, at least 80 wt. %, at least 90 wt. %, at least 95 wt. %, or at least 99 wt. %, based on the total weight of the monomer (a2), of two 4,4′-difluorodiphenylketones of following formula:

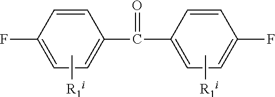

wherein
in one of the 4,4′-difluorodiphenylketones, both i equal 0; and
in the other 4,4′-difluorodiphenylketone, both i=1 and each R₁ is independently selected from the group consisting of alkali or alkaline earth metal sulfonates and alkyl sulfonates.

In alternate embodiments for preparing the PAEK copolymer (P0), each R₁ in the 4,4′-difluorodiphenylketone is selected from the group consisting of alkali or alkaline earth metal sulfonates and alkyl sulfonates, and its corresponding i equals 1. In such instance, the monomer (a2) is preferably disodium sulfonated 4,4′-difluorodiphenylketone.

For preparing the amorphous PAEK copolymer (P0), the monomer (a2) preferably comprises at least 50 wt. %, at least 60 wt. %, at least 70 wt. %, at least 80 wt. %, at least 90 wt. %, at least 95 wt. %, or at least 99 wt. %, based on the total weight of the monomer (a2), or consists of, 4,4′-difluorobenzophenone (DFBP) and/or disulfonated 4,4′-difluorobenzophenone (sDFBP). When the monomer (a2) comprises both DFBP and sDFBP, then the monomer (a2) preferably contains more than 50 mol. % of DFBP, based on the combined number of moles of DFBP and sDFBP in the monomer (a2). The monomer (a2) preferably consists essentially of DFBP.

To prepare the PAE copolymer (P0), the monomers (a1), (a2) and (a3) of the reaction mixture are generally reacted concurrently. The reaction is preferably conducted in one stage. This means that the deprotonation of monomers (a1) and (a3) and the condensation reaction between the monomers (a1)+(a3) and (a2) takes place in a single reaction stage without isolation of intermediate products.

The condensation may be carried out in a mixture of a polar aprotic solvent S₀ and a co-solvent which forms an azeotrope with water. The co-solvent which forms an azeotrope with water includes aromatic hydrocarbons such as benzene, toluene, xylene, ethylbenzene, chlorobenzene and the like. The co-solvent is preferably toluene or chlorobenzene. The azeotrope forming co-solvent and polar aprotic solvent S₀ are used typically in a weight ratio of from about 1:100 to about 1:1, preferably from about 1:10 to about 1:1, more preferably from about 1:5 to about 1:1. Water is continuously removed from the reaction mass as an azeotrope with the azeotrope forming co-solvent so that substantially anhydrous conditions are maintained during the polymerization. The azeotrope-forming co-solvent, for example, chlorobenzene or toluene, is removed from the reaction mixture, typically by distillation, after the water formed in the reaction is removed leaving the copolymer (P0) dissolved in the polar aprotic solvent.

The temperature of the reaction mixture to prepare the PAE copolymer (P0) is kept at about 150° C. to about 250° C., preferably from about 165° C. to about 250° C., for about one to 15 hours. Preferred temperature of the reaction mixture may be from from about 180° C. to about 220° C. when NMP or sulfolane is used as solvent S₀. Preferred temperature of the reaction mixture may be from about 150° C. to about 170° C. when DMAc is used as solvent S₀.

The inorganic constituents, for example sodium chloride or potassium chloride or excess of base, can be removed, before or after isolation of the copolymer (P0), by suitable methods such as dissolving and filtering, screening or extracting.

The amount of copolymer (P0) at the end of the condensation is at least 30 wt. % based on the total weight of the copolymer (P0) and the polar aprotic solvent S₀, for example at least 35 wt. % or at least or at least 37 wt. % or at least 40 wt. %.

At the end of the condensation reaction, the copolymer (P0) is separated from the other components (salts, base, . . . ) to obtain a solution. Filtration can for example be used to separate the copolymer (P0) from the other components.

The solution containing the PAE copolymer (P0) can then be used as such for reacting the PAE copolymer (P0) with the vinyl pyrrolidone monomer in the process of the present invention to manufacture the graft PAE copolymer (P1) according to the invention and which is described herein. Alternatively, the PAE copolymer (P0) can be recovered in solid form from the solvent S₀ (used during condensation), for example by coagulation or devolatilization of the solvent S₀. The PAE copolymer (P0) in solid form may be dissolved in the solvent S₁ (same or different than S₀) used for the manufacture of the PAE copolymer (P1).

The PAE copolymer (P0) is an intermediate product used for the preparation of the graft PAE copolymer (P1) according to the invention.

### Use of the Graft PAE Copolymer (P1)

Another aspect of the present invention provides the use of the graft PAE copolymer (P1) for preparing an article (or a part thereof) as described herein.

### Method for Preparing an Article

Another aspect of the present invention provides a method for preparing an article (or a part thereof) comprising the graft PAE copolymer (P1).

The article may be formed from a solution comprising the graft PAE copolymer (P1).

When the article is a membrane or a part thereof, the method preferably includes a phase inversion occurring in a liquid phase (e.g., precipitation bath) to form the membrane or part thereof.

An aspect of the present invention relates to a method of making an article comprising the graft PAE copolymer (P1). The method for making the article may comprise performing one of the following methods:
method (a): using the graft PAE copolymer (P1) in forming the article or part thereof; or
method (b): contacting a pre-formed article or part thereof comprising the PAE copolymer (P0) with the vinyl monomer and the free radical initiator to form the graft PAE copolymer (P1) from copolymer (P0).

For method (b), the pre-formed article may be prepared by a phase inversion technique occurring in a liquid phase. Said method (b) may further comprise the following steps: preparing a polymer solution comprising the copolymer (P0) described herein and a polar solvent, processing said polymer solution into a pre-formed article or part thereof; and contacting said pre-formed article or part thereof with a non-solvent bath. This is particular applicable when the pre-formed article or part thereof is a membrane, fiber or film.

### Article Comprising the Graft PAE Copolymer (P1)

Another aspect of the present invention provides an article (preferably a shaped article) comprising the graft PAE copolymer (P1) according to the present invention.

An article comprising the graft PAE copolymer (P1) may be selected from the group consisting of membranes (e.g., solution casted membranes); fibers; sheets; solution processed films (e.g., porous or non-porous films); and solution processed monofilaments.

The graft PAE copolymer (P1) can be incorporated into articles having a polymeric surface. The article can have a polymeric surface, at least a portion of which comes into direct contact with an aqueous media, such as water, an aqueous solution, a biological fluid and/or food product in its intended application setting. The polymeric surface may be an external or internal surface of the article. For example, a medical device has an external surface intended to come into direct contact with a biological fluid, such as blood, plasma or serum. A person of ordinary skill in the art will know which surface is intended to contact a biological fluid or food product based upon the article's intended application setting.

As another example, a surface of the article can comprise a coating or film comprising the graft PAE copolymer (P1), disposed on an underlying substrate. In such embodiments, the underlying substrate can be a structural component having a composition distinct from the graft PAE copolymer (P1).

In embodiments in which the graft PAE copolymer (P1) is in a film, the film can have an average thickness of from about 25 μm to about 1 mm.

The graft PAE copolymer (P1) can be included in at least a portion of a surface of the article which is intended for such surface to come in contact with a biological fluid such as blood, plasma, or serum. Alternatively, the graft PAE copolymer (P1) can form all, or substantially all, of the article.

A shaped article comprising the graft PAE copolymer (P1) preferably may be a membrane, or a part thereof, being selected from proton exchange membranes, membranes for bioprocessing (e.g., enzyme or cell culture filtration), membranes for medical filtrations, e.g., hemodialysis membranes, membranes for food and beverage processing, membranes for water purification, membranes for wastewater treatment and membranes for industrial process separations involving aqueous media.

Among membranes, the graft PAE copolymer (P1) according to the present invention is particularly suitable for manufacturing membranes intended for contact with an aqueous medium. The aqueous medium may include a biological fluid, such as blood, or a food product, such as beverages (e.g., fruit juice, milk, beer).

From an architectural perspective, membranes comprising the graft PAE copolymer (P1) may be provided under the form of flat structures (e.g. films or sheets), corrugated structures (such as corrugated sheets), tubular structures, or hollow fibers; as per the pore size is concerned, full range of membranes (non-porous and porous, including for microfiltration, ultrafiltration, nanofiltration, and reverse osmosis) can be advantageously manufactured with the graft PAE copolymer (P1); the pore distribution can be isotropic or anisotropic.

Among applications of use, mention can be made of healthcare applications, in particular medical applications, wherein shaped articles comprising the graft PAE copolymer (P1) can advantageously be used in single-use and reusable instruments and devices.

Among applications of use, mention can be made of fuel cell applications, wherein the graft PAE copolymer (P1) can advantageously be used in proton exchange membranes.

The article may comprise the graft PAE copolymer (P1) and optionally another sulfone polymer distinct from the copolymer (P1), e.g., the PAE copolymer (P0), PSU, PES, PPSU, in an amount ranging from 1 to 99 wt. %, for example from 2 to 98 wt. %, from 3 to 97 wt. % or from 4 to 96 wt. %, based on the total weight of polymers. In such instances when the article comprises the copolymer (P1) and another sulfone polymer such PAE copolymer (P0), PSU, PES and/or PPSU, the weight fraction of the copolymer (P1) based on the combined weights of copolymer (P1) and the other sulfone polymer(s) in the article is at least 10 wt % or at least 15 wt % or at least 20 wt % or at least 25 wt % and/or up to 99 wt % or up to 98 wt % or up to 96 wt % or up to 95 wt % or up to 90 wt %.

As used herein, a polyethersulfone (PES) denotes any polymer comprising at least 50 mol. %, at least 60 mol. %, at least 70 mol. %, at least 80 mol. %, at least 90 mol. %, at least 95 mol. %, or at least 99 mol. % of recurring units (R_{PES}) of formula (J):

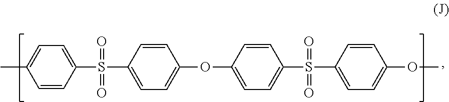

(the mol. % being based on the total number of moles of recurring units in the PES polymer). PES can be prepared by known methods and is notably available as VERADEL® PESU from Solvay Specialty Polymers USA, L.L.C.

As used herein, a polysulfone (PSU) denotes any polymer comprising at least 50 mol., at least 60 mol. %, at least 70 mol. %, at least 80 mol. %, at least 90 mol. %, at least 95 mol. %, or at least 99 mol. % of recurring units (R_{PSU}) of formula (K):

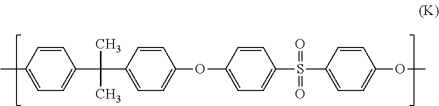

(the mol. % being based on the total number of moles of recurring units in the PSU polymer). PSU can be prepared by known methods and is notably available as Udel® PSU from Solvay Specialty Polymers USA, L.L.C.

As used herein, a polyphenylsulfone (PPSU) denotes any polymer comprising at least 50 mol. %, at least 60 mol. %, at least 70 mol. %, at least 80 mol. %, at least 90 mol. %, at least 95 mol. %, or at least 99 mol. % of recurring units (R_{PPSU}) of formula (L):

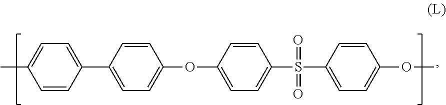

(the mol. % being based on the total number of moles of recurring units in the PPSU polymer). PPSU can be prepared by known methods and is notably available as RADEL® PPSU from Solvay Specialty Polymers USA, L.L.C.

### Membrane, Fiber or Film (as Article)

The article may be a film, a fiber, a membrane, or a part thereof.

A particular embodiment of an article (preferably a shaped article) relates to a membrane comprising the graft PAE copolymer (P1). The membrane may be used for proton exchange or for purifying water, a food product, or a biological fluid, such as blood.

An embodiment of a membrane according to the invention relates to a proton exchange membrane comprising the graft PAE copolymer (P1).

Another embodiment of a membrane according to the invention relates to a purification membrane comprising the graft PAE copolymer (P1), such as for purifying water, a food product, or a biological fluid, such as blood.

A membrane may be a microporous membrane which can be characterized by its average pore diameter and porosity, i.e., the fraction of the total membrane that is porous.

The membrane may have a gravimetric porosity (%) of 20 to 90% and comprises pores, wherein at least 90% by volume of the said pores has an average pore diameter of less than 5 μm. Gravimetric porosity of the membrane is defined as the volume of the pores divided by the total volume of the membrane.

Membranes having a uniform structure throughout their thickness are generally known as symmetrical membranes; membranes having pores which are not homogeneously distributed throughout their thickness are generally known as asymmetric membranes. Asymmetric membranes are characterized by a thin selective layer (0.1-1 μm thick) and a highly porous thick layer (100-200 μm thick) which acts as a support and has little effect on the separation characteristics of the membrane.

Membranes can be in the form of a flat sheet or in the form of tubes.

A membrane may be formed using a plurality of films or a plurality of fibers.

Tubular membranes are classified based on their dimensions in tubular membranes having a diameter greater than 3 mm; capillary membranes, having a diameter comprised between 0.5 mm and 3 mm; and hollow fibers having a diameter of less than 0.5 mm. Capillary membranes are otherwise referred to as hollow fibers.

Hollow fibers are particularly advantageous in applications where compact modules with high surface areas are required.

The membrane, fiber or film according to the present invention can be manufactured using any of the conventionally known membrane, fiber or film preparation methods, for example, by a solution casting method.

The membrane, fiber or film according to the present invention may be prepared by a phase inversion method occurring in a liquid phase, said method comprising the following steps: preparing a polymer solution comprising the copolymer (P1) described herein and a polar solvent, processing said polymer solution into a film; and contacting said film with a non-solvent bath.

The membrane, fiber or film may further comprise at least one polymer distinct from the graft PAE copolymer (P1) described herein. For example the membrane, fiber or film may further comprise at least one additional polymer selected from the group consisting of the PAE copolymer (P0), another sulfone polymer such as polysulfone (PSU), polyethersulfone (PES), poly(biphenyl ether sulfone) (PPSU), a polyphenylene sulfide (PPS), a poly(aryl ether ketone) (PAEK) such as a poly(ether ether ketone) (PEEK), a poly(ether ketone ketone) (PEKK), a poly(ether ketone) (PEK) or a copolymer of PEEK and poly(diphenyl ether ketone) (PEEK-PEDEK copolymer), a polylactide (PLA), a polyetherimide (PEI), a polycarbonate (PC), a polyphenylene oxide (PPO), polyvinylpyrrolidone (PVP) and/or polyethylene glycol (PEG). When the membrane, fiber or film further comprises at least one polymer distinct from the graft PAE copolymer (P1), the at least distinct polymer preferably excludes a PVP.

More preferably, when the membrane, fiber or film further comprises at least another polymer distinct from the copolymer (P1), such distinct polymer may be selected from the group consisting of the PAE copolymer (P0), PSU, PES, PPSU, PC, PPO, PEI, PLA, and any combination thereof.

The membrane, fiber or film may comprise the graft PAE copolymer (P1) of the present invention in an amount of at least 1 wt. %, or at least 2 wt. %, at least 3 wt. %, at least 4 wt. %, at least 5 wt. %, at least 6 wt. %, or at least 7 wt. %, or at least 8 wt. %, based on the total weight of the polymers, and/or may comprise the copolymer (P1) described herein in an amount of more than 50 wt. %, for example more than 55 wt. %, more than 60 wt. %, more than 65 wt. %, more than 70 wt. %, more than 75 wt. %, more than 80 wt. %, more than 85 wt. %, more than 90 wt. %, more than 92 wt. %, or more than 95 wt. %, based on the total weight of the polymers.

According to an embodiment, the membrane, fiber or film may comprise the graft PAE copolymer (P1) and optionally another sulfone polymer distinct from the copolymer (P1), e.g., the copolymer (P0), PSU, PES, PPSU, in an amount ranging from 1 to 99 wt. %, for example from 2 to 98 wt. %, from 3 to 97 wt. % or from 4 to 96 wt. %, based on the total weight of polymers. In such instances when the membrane, fiber or film comprises the graft copolymer (P1) and another sulfone polymer such PSU, PES and/or PPSU, the weight fraction of the graft copolymer (P1), based on the combined weights of the copolymer (P1) and the other sulfone polymer(s) in the membrane, fiber or film, is at least 10 wt % or at least 15 wt % or at least 20 wt % or at least 25 wt % and/or up to 99 wt % or up to 98 wt % or up to 96 wt % or up to 95 wt % or up to 90 wt %.

The membrane, fiber or film may further comprise at least one non-polymeric ingredient such as a solvent, a filler, a lubricant, a mold release, an antistatic agent, a flame retardant, an anti-fogging agent, a matting agent, a pigment, a dye and an optical brightener.

A suitable example of a method for forming a membrane from a polyaryl ether sulfone polymer is described in US2019/054429A1 (Solvay Specialty Polymers USA), incorporated herein by reference.

### Polymer Solution (SP) for Preparing a Membrane, Fiber or Film

Another aspect of the present invention is directed to a polymer solution (SP) for preparing a membrane, fiber or film, which comprises the graft PAE copolymer (P1) in a polar organic solvent [solvent (S_{SP})].

The polymer solution (SP) may further comprise at least one additional polymer distinct from the graft PAE copolymer (P1) described herein, for example another sulfone polymer, e.g., copolymer (P0), PSU, PES, PPSU; a PPS; a PAEK, e.g., PEEK, PEKK, PEK or a PEEK-PEDEK copolymer; PPO; PLA; PEI; PC; PVP; and/or PEG. The polymer solution (SP) preferably excludes PVP.

The overall concentration of the graft PAE copolymer (P1) and optional additional polymer(s) in polymer solution (SP) may be at least 8 wt. %, or preferably at least 10 wt. %, based on the total SP weight and/or is at most 70 wt. %; or at most 60 wt. %; or at most 50 wt. %; or at most 40 wt. %; or at most 30 wt. %, based on the total polymer solution weight. Concentrations of all polymers in SP ranging between 10 and 25% wt, and more preferably between 10 and 22% wt, based on the total SP weight are particularly advantageous.

The concentration of the solvent (S_{SP}) in SP may be at least 20 wt. %, preferably at least 30 wt. %, based on the total SP weight and/or is at most 70 wt. %; preferably, at most 65 wt. %; more preferably, at most 60 wt. %, based on the total SP weight.

The solvent (S_{SP}) in SP may be selected from the list of solvent provided for solvent S₁ described earlier. Preferably the solvent (S_{SP}) in polymer solution (SP) is N,N′-dimethylacetamide (DMAc), sulfolane, or NMP, particularly suitable for preparing membranes or films.

Exemplary solvents (S_{SP}) which may be used, alone or in combination, in polymer solution (SP) are described in patent applications in US2019/054429A1 (Solvay Specialty Polymers Italy), in particular solvents described in paragraphs [0057]-[0129], and WO 2019/048652 (Solvay Specialty Polymers USA), incorporated herein by reference.

The polymer solution (SP) may contain additional components, such as nucleating agents, fillers and the like.

### Purification Method for a Biological Fluid

A further aspect of the present invention may be directed to a purification method comprises at least a filtration step through a membrane, fiber(s) or film(s) comprising the graft PAE copolymer (P1) described herein.

Preferably, the purification method is for purifying a human biological fluid, preferably a blood product, such as whole blood, plasma, fractionated blood components or mixtures thereof, that is carried out in an extracorporeal circuit. The extracorporeal circuit for carrying out a method comprises at least one filtering device (or filter) comprising at least one membrane, fiber(s) or film(s) as described above.

As intended herein, a blood purification method through an extracorporeal circuit comprises hemodialysis (FD) by diffusion, hemofiltration (HF), hemodyafiltration (HDF) and hemoconcentration. In HF, blood is filtered by ultrafiltration, while in HDF blood is filtered by a combination of FD and HF.

Blood purification methods through an extracorporeal circuit are typically carried out by means of a hemodialyzer, i.e., equipment designed to implement any one of FD, HF or HFD. In such methods, blood is filtered from waste solutes and fluids, like urea, potassium, creatinine and uric acid, thereby providing waste solutes- and fluids-free blood.

Typically, a hemodialyzer for carrying out a blood purification method comprises a cylindrical bundle of hollow fibers of membranes, said bundle having two ends, each of them being anchored into a so-called potting compound, which is usually a polymeric material acting as a glue which keeps the bundle ends together. Potting compounds are known in the art and include notably polyurethanes. By applying a pressure gradient, blood is pumped through the bundle of membranes via the blood ports and the filtration product (the “dialysate”) is pumped through the space surrounding the fibers.

The invention will be now described in more detail with reference to the following examples whose purpose is merely illustrative and not limitative of the scope of the invention.

### EXAMPLES

### Raw Materials

K₂CO₃ (potassium carbonate), available from Armand products
daBPA (2,2′-diallyl Bisphenol A), available from Sigma-Aldrich, U.S.A.
DCDPS (4,4′-dichlorodiphenyl sulfone), available from Solvay Speciality Polymers
DHDPS (4,4′-dihydroxydiphenyl sulfone or Bisphenol S), available from Konishi chemicals, Japan.
DFBP (4,4′-difluorobenzophenone), available from Sigma-Aldrich, U.S.A.
Resorcinol, available from Sigma-Aldrich, U.S.A.
DMAc (dimethylacetamine), available from Sigma-Aldrich, U.S.A.
NMP (2-methyl pyrrolidone), available from Sigma-Aldrich, U.S.A.
Sulfolane, available from Chevron Phillips
AIBN (azobisisobutyronitrile), available from Sigma-Aldrich, U.S.A.
Vinyl pyrrolidone (VP), available from Sigma-Aldrich, U.S.A.
Methanol, available from Sigma-Aldrich, U.S.A.
Ethyl acetate, available from Sigma-Aldrich, U.S.A.

### Test Methods

### GPC Method 1 for Measuring Molecular Weight (Mn, Mw)

Instrument: Waters 515 pump, Waters 717plus autosampler, Waters 2487 Absorbance Detector, Waters 2414 Refractive Index Detector
Columns: Two Agilent PLgel MiniMix-D, 5 um, 250×4 mm (Part #PL1510-5504)+Agilent Mix Guard, 5 um, 50×4.6 mm (Part #PL1510-1504)
Column Temperature: 45 C
Mobile Phase: N,N-Dimethylacetamide+0.1M LiBr
Flow Rate: 0.3 ml/min
Injection Volume: 20 ul
UV Detection: 270 nm
RI Detection: +polarity
Calibration: Agilent EasiCal PS-2 GPC/SEC Standards (Part #PL2010-0601). Standards are dissolved in Mobile Phase.

Sample Preparation: Weigh 30 mg of sample into a 20 ml glass vial with PTFE lined cap. Add 5 mL of DMAC Mobile Phase. Heat to 105 C with stirring to complete dissolution. Filter through 0.2 um PTFE syringe filter into a 4 ml autosampler vial

GPC Method 2 for measuring Molecular weight (Mn, Mw)

The molecular weights were measured by gel permeation chromatography (GPC), using methylene chloride as a mobile phase. Two 5p mixed D columns with guard column from Agilent Technologies were used for separation. An ultraviolet detector of 254 nm was used to obtain the chromatogram. A flow rate of 1.5 ml/min and injection volume of 20 μL of a 0.2 w/v % solution in mobile phase was selected. Calibration was performed with 12 narrow molecular weight polystyrene standards (Peak molecular weight range: 371,000 to 580 g/mol). The number average molecular weight Mn, weight average molecular weight Mw, higher average molecular weight Mz, were reported.

### Thermal Gravimetric Analysis (TGA)

TGA experiments were carried out using a TA Instrument TGA Q500. TGA measurements were obtained by heating the sample at a heating rate of 10° C./min from 20° C. to 800° C. under nitrogen.

### ¹H NMR

¹H NMR spectra were measured using a 400 MHz Bruker spectrometer with TCE as the deuterated solvent. All spectra are reference to residual proton in the solvent.

### DSC

DSC was used to determine glass transition temperatures (Tg) and melting points (Tm)-if present. DSC experiments were carried out using a TA Instrument Q100.

DSC curves were recorded by heating, cooling, re-heating, and then re-cooling the sample between 25° C. and 320° C. at a heating and cooling rate of 20° C./min. All DSC measurements were taken under a nitrogen purge. The reported Tg values (and if any, Tm values) were provided using the second heat curve unless otherwise noted.

### Elemental Analysis

Elemental composition of some polymer samples was determined using a Perkin Elmer 2400 CHN Element Analyzer. The polymer samples were combusted based on the classical Pregl-Dumas method. The resultant combustion gases were completely reduced to CO₂, H₂O, N₂, and SO₂. Then the gases were separated via Frontal Chromatography. As the gases eluted they were measured by a thermal conductivity detector to determine quantitative amounts of Carbon, Hydrogen, Nitrogen and Sulfur.

### FTIR

Because the vinyl pyrrolidone is a liquid and highly water soluble and because of the extensive washing, filtration and drying of the graft copolymer (P1) samples, there should be non-detectable free vinyl monomer in the dried sample of graft copolymer (P1). Nonetheless, free residual vinyl monomer can be detected by FTIR using a Bruker Optics Vertex 70 FTIR Bench with MIR source. The spectra were obtained in absorption mode across a diamond ATR crystal.

The procedure for FTIR analysis for the referenced samples was as follows:
a background spectrum was established with fresh 18 megohm water;
a drop of polymer sample was applied to the ATR crystal to ensured its complete coverage;
32 replicate scans of the spectrum were gathered to produce an average response;
the following correction to each spectrum was applied:
   Extended ATR correction for Diamond
   Atmospheric correction for water and CO₂
   Baseline correctionNormalize all spectra together based on their Max-min peak values.
the normalized spectra were overlaid; and
the peak heights at 1641 cm⁻¹ were visually compared.

### I. Preparation of Side Chain Allyl/Vinylene-Functionalized PAES Copolymer (P0-A)

The PAES copolymer (P0-A) was prepared according to Scheme 1.

To generate the recurring units (R_{P0a}), 4,4′-dichlorodiphenyl sulfone (DCDPS) and 4,4′-dihydroxydiphenyl sulfone or Bisphenol S (DHDPS) were used while diallyl bisphenol A (daBPA) and DCDPS were used to generate the recurring units (R*_{P0a}). The target mol. % for recurring units (R*_{P0a}) in the side-chain allyl/vinylene-functionalized polymer (P0-A) was 9.1 mol. % to achieve a molar ratio of recurring units (R_{P0a})/recurring units (R*_{P0a}) of 10:1. That is to say, the value ‘n’ in Scheme 1 for the main recurring unit (R_{P0a}) should be about 90.9 mol. %, and the combined values: m1+m2+m3 for the three illustrated functionalized recurring units (R*_{P0a}) should be 9.1 mol. %, said mol. % being based on the total number of moles of recurring units in the PAES copolymer (P0-A).

The polymerization took place in a 20-L glass reactor vessel fitted with an overhead stirrer, a nitrogen inlet and an overhead distillation set-up. The monomers DCDPS (2030.2 g; 7.07 moles), DHDPS (1594.2 g, 6.37 moles) and daBPA (197.25 g; 0.64 mole) were added to the vessel first, followed by the addition of potassium carbonate (977.14 g; 7.07 moles) and NMP (4018.9 g).

The reaction mixture was heated from room temperature to 190° C. using a 10° C./min heating ramp. The temperature of the reaction mixture was maintained for around six hours, depending upon the viscosity of the solution. The reaction was terminated by adding excess DCDPS (140.7 g) thereby allowing the DCDPS to end cap the polymer for another 30 minutes and then stopping the heat. The reaction mixture was filtered, coagulated into methanol. The polymer was then washed with methanol and water and again with methanol and dried at 110° C.

### Characterization of the PAES Copolymer (P0-A)

### GPC Method 2:

$$\begin{matrix}{M}_{w} = 58566 g / mol , {M}_{n} = 21327 g / mol , PDI = 2.75 \\ TGA : 488 ° C . \\ DSC : Tg = 218 ° C .\end{matrix}$$

¹H NMR: The presence of unsaturated groups was confirmed by the appearance of a multiplet at 6.1-6.4 ppm which indicated the incorporation of the 2,2′-diallyl bisphenol A monomer in the polymer (P0-A).

The estimated olefin content measured by ¹H NMR was 8.97 mol %. This value provided an actual molar ratio of recurring units (R_{P0a})/recurring units (R*_{P0a}) of 10.15:1. The actual value ‘n’ in Scheme 1 for the main recurring unit (R_{P0a}) of PAES copolymer (P0-A) was 91.03 mol. %.

### II. Preparation of Graft PAES Copolymer (P1-A) by Free Radical Reaction

The graft PAES copolymer (P1-A) was prepared according to Scheme 2. The actual value ‘n’ in Scheme 2 for the main recurring unit (R_{P1a}) in PAES copolymer (P1-A) was 91.03 mol. %, same as PAES copolymer (P0-A).

The reaction took place in a 2-L glass reactor vessel fitted with an overhead stirrer and a nitrogen inlet. A sample of the side chain allyl/vinylene-functionalized PAES copolymer (P0-A) (64 g containing 0.024 moles of olefinic double bonds) and vinyl pyrrolidone (184.32 g; 1.658 moles) were added to the reactor and this mixture was dissolved in anhydrous NMP (1727 g) and heated to 65° C. The molar ratio of number of moles of vinyl pyrrolidone monomer to the number of moles of the functionalized recurring units in the PAES copolymer (P0-A) was 69.1. The reaction was purged with nitrogen for 30 minutes and then AIBN (2.34 g) was added in a single portion. The reaction was allowed to continue for 12 hours at 65° C. After 12 hours, the reaction mixture was cooled and about 70-80% of the solvent distilled off under reduced pressure. The copolymer (P1-A) was isolated by coagulating in ethyl acetate and the copolymer (P1-A) was washed repeatedly with hot water until no free polyvinyl pyrrolidone was detected in the water washes via FTIR. The purified copolymer (P1-A) was dried at 100° C. under high vacuum.

### Characterization of Graft Polyarylethersulfone Copolymer (P1-A)

### GPC Method (RI Detector):

$$\begin{matrix}Mn = 80752 g / mol , Mw = 672825 g / mol = 8.3 \\ DSC : Tg = 209 ° C . \\ TGA : 414 ° C .\end{matrix}$$

The estimation of mol % of PVP in the copolymer (P1-A) was analyzed by ¹H NMR in deuteriated TCE solvent by integrating the peaks attributed to polyvinylpyrrolidone attached to the polyarylethersulfone using the following equation:

$$mol PVP = \frac{\frac{( \int PVP - \int PSU )}{\# H PVP}}{( \frac{( \int PVP - \int PSU )}{\# H PVP} + \frac{\int PSU}{\# H PSU} )}$$

in which ∫PVP and ∫PSU would denote the sum of all the hydrogen protons of PVP and PSU signals respectively; and in which #H PVP and #H PSU denote the number of protons corresponding to the PVP and PSU molecules, respectively. Then, the PVP weight content (wt. %) in the graft polyarylethersulfone copolymer (P1-A) sample was calculated based on the following equation:

$$wt . \% PVP = ( ( mol PVP ) ( molecular weight PVP ) ) / ( ( g PVP + g PSU ) ) , \qquad ( 100 )$$

in which the mol PVP was measured by ¹H NMR as described above; the molecular weight of PVP was 111.1 g/mol and the denominator term: (g PVP+g PSU) was the weight of the graft polyarylethersulfone copolymer (P1-A) sample used for ¹H NMR analysis.

¹H NMR: 56.2 wt. % PVP

### III. Preparation of Side Chain-Allyl/Vinylene-Functionalized PAEK Copolymer (P0-B)

The PAEK copolymer (P0-B) was prepared according to the Scheme 3.

To generate the recurring units (R_{P0b}), 4,4′-difluorobenzophenone (DFBP) and resorcinol were used, while to generate the recurring units (R*_{P0b}), diallyl bisphenol A (daBPA) and DFBP were used. The target mol. % for recurring units (R*_{P0b}) in the side-chain allyl/vinylene-functionalized polymer (P0-B) was 60 mol. % to achieve a molar ratio of recurring units (R_{P0b})/recurring units (R*_{P0b}) of 2:3. That is to say, the value ‘n’ in Scheme 3 for the main recurring unit (R_{P0b}) should be about 40 mol. %, and the value “1-n” for the functionalized recurring units (R*_{P0b}) should be 60 mol. %, said mol. % being based on the total number of moles of recurring units in the PAEK copolymer (P0-B).

The polymerization took place in a 1-L glass reactor vessel fitted with an overhead stirrer, a nitrogen inlet and an overhead distillation set-up. The monomers: DFBP (283.66 g; 1.3 moles), resorcinol (57.25 g; 0.52 mole) and daBPA (240.55 g; 0.78 mole) were added to the vessel first, followed by the addition of potassium carbonate (188.64 g; 1.365 moles) and sulfolane (1235 g). The reaction mixture was heated from room temperature to 210° C. using a 15° C./mi heating ramp. The temperature of the reaction mixture was maintained for around five hours, depending upon the viscosity of the solution. The reaction was terminated by stopping the heat to the reactor vessel and by diluting with cold sulfolane. The reaction mixture was filtered; the PAEK copolymer (P0-B) was coagulated into methanol and then dried at 110° C.

### Characterization of PAEK Copolymer (P0-B)

### GPC Method (RI Detector):

$$\begin{matrix}Mw = 54998 g / mol , Mn = 17477 g / mol , PDI = 3.14 \\ TGA : 428 ° C . \\ DSC : Tg = 121 ° C .\end{matrix}$$

¹H NMR: The presence of unsaturated groups was confirmed by the appearance of a multiplet at 6.1-6.4 ppm which indicated the incorporation of the 2,2′-diallyl bisphenol A monomer in the polymer (P0-B).

The estimated olefin content measured by ¹H NMR was 65.6 mol %. This value provided an actual molar ratio of recurring units (R_{P0b})/recurring units (R*_{P0b}) of 0.52:1. The actual value ‘n’ in Scheme 3 for the main recurring unit (R_{P0b}) in PAEK copolymer (P0-B) was 34.6 mol. %.

The PAEK copolymer (P0-B) was amorphous, as there was no Tm observed via DSC.

### IV. Preparation of Graft PAEK Copolymer (P1-B) by Free Radical Reaction

The graft PAEK copolymer (P1-B) was prepared according to Scheme 4. The actual value ‘n’ in Scheme 4 for the main recurring unit (R_{P1b}) in PAEK copolymer (P1-B) was 34.6 mol. %, same as PAEK copolymer (P0-B).

The reaction took place in a 2-L glass reactor vessel fitted with an overhead stirrer and a nitrogen inlet. A sample of the allyl/vinylene-functionalized PAEK copolymer (P0-B) (12.2 g containing 0.035 moles of unsaturated groups) and vinyl pyrrolidone (268 g; 2.41 moles) were added to the reactor vessel, and the mixture was dissolved in anhydrous NMP (1588 g) and heated to 65° C. The molar ratio of number of moles of vinyl pyrrolidone monomer to the number of moles of the functionalized recurring units in the amorphous PAEK copolymer (P0-B) was 69:1. The reaction vessel was purged with nitrogen for 30 minutes, and then AIBN (3.35 g) was added in a single portion. The reaction was allowed to continue for 12 hours at 65° C. After this period of 12 hours, the reaction mixture was cooled, and about 70-80% of the NMP solvent distilled off under reduced subatmospheric pressure. The PAEK copolymer (P1-B) was isolated by coagulating in ethyl acetate. The graft PAEK copolymer (P1-B) precipitate was washed repeatedly with hot water until no free polyvinyl pyrrolidone was detected in the water washes via FTIR. The purified graft PAEK copolymer (P1-B) was dried at 100° C. under high vacuum.

### Characterization of Graft PAEK Copolymer (P1-B)

### GPC Method (RI Detector):

$$\begin{matrix}Mw = 309148 g / mol , Mn = 47468 g / mol , PDI = 6.5 \\ TGA : 411 ° C \\ DSC : Tg = 126 ° C .\end{matrix}$$

Nitrogen content: 9.89 wt. %

The nitrogen content came from the PVP attached to the parent polyarylether polymer (P0-B) and was measured by elemental analysis for which the method was described above.

The graft PAEK copolymer (P1-B) was amorphous, as there was no Tm observed via DSC.

Accordingly, the scope of protection is not limited by the description set out above, but is only limited by the claims which follow. Each and every claim is incorporated into the specification as an embodiment of the present invention. Thus, the claims are a further description and are an addition to the preferred embodiments of the present invention.

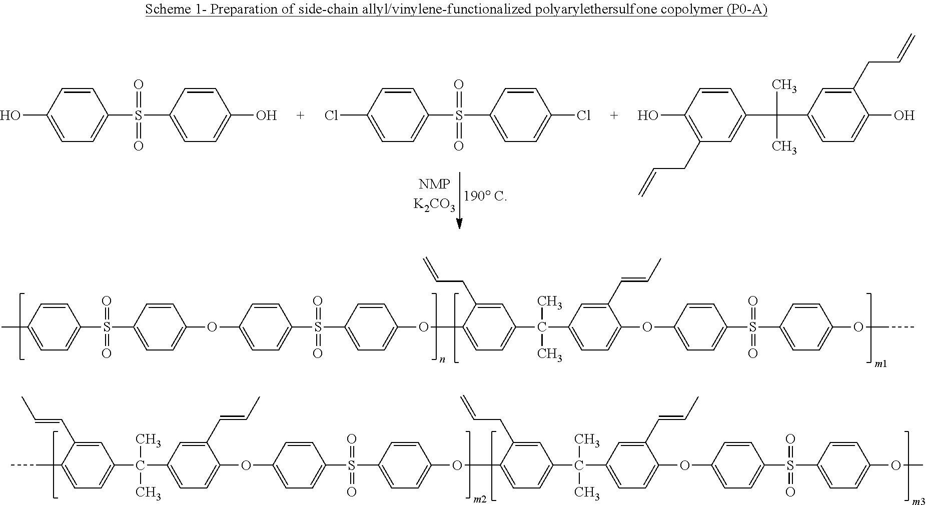

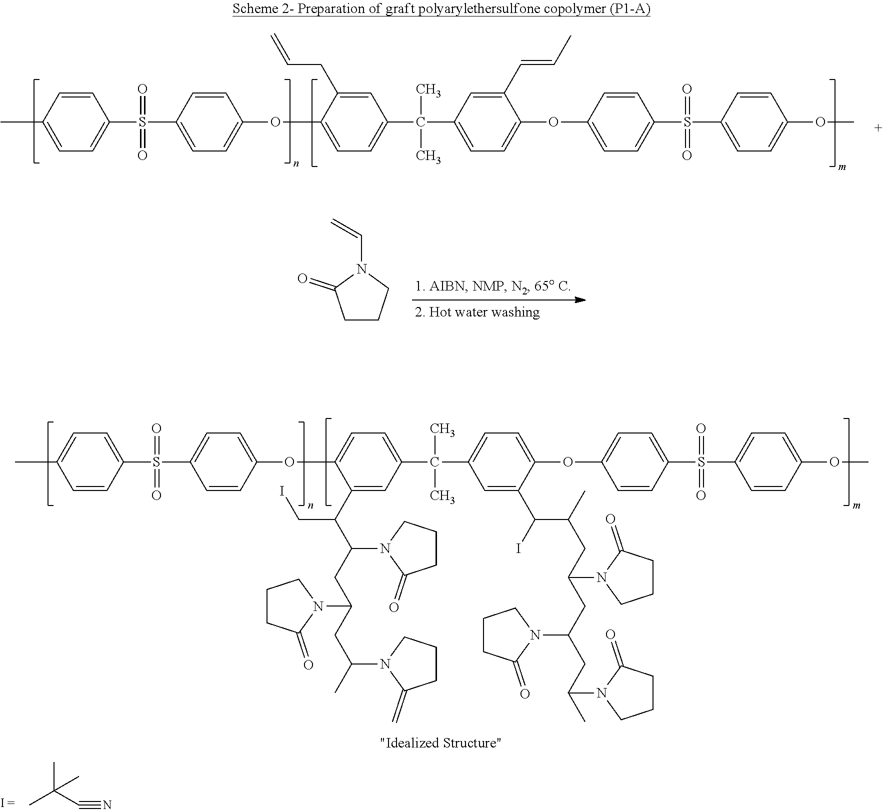

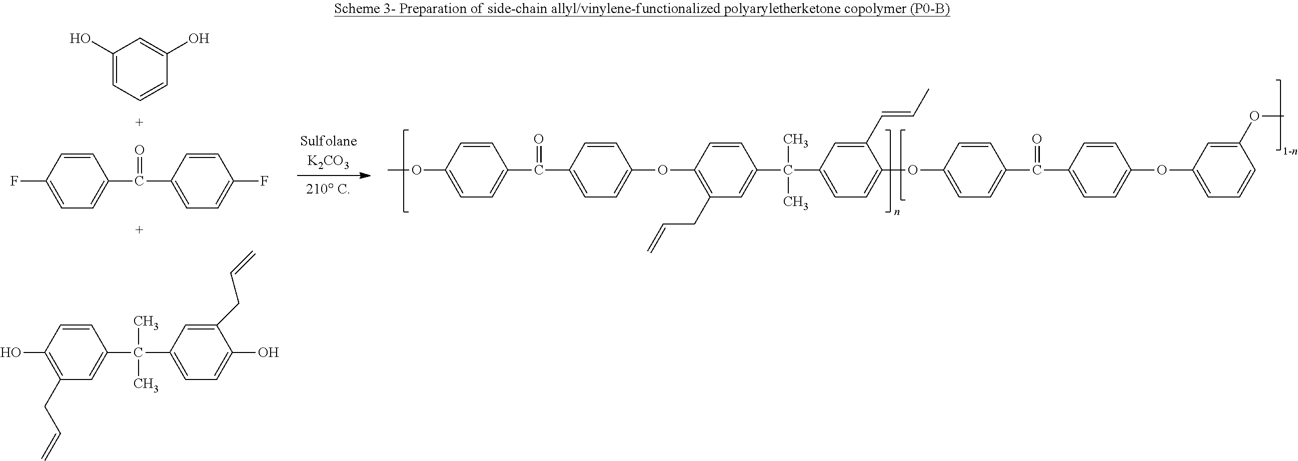

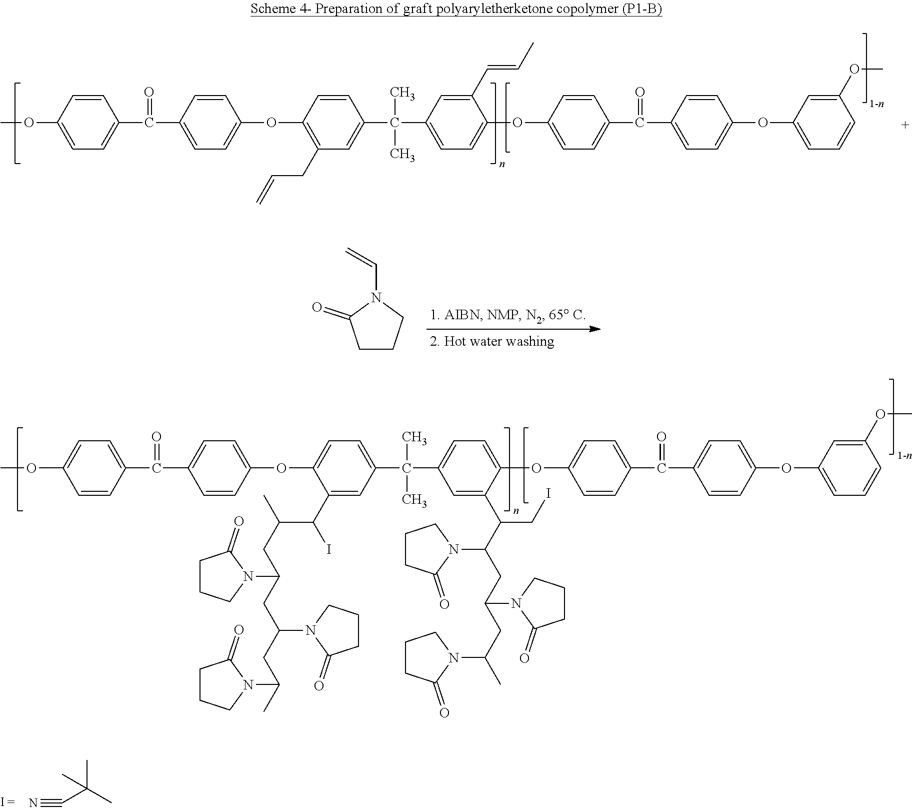

1. A graft polyarylether (“PAE”) copolymer (P1) comprising:
collectively at least 50 mol. % of sulfone recurring units (R_{P1a}) of formula (M1) and functionalized sulfone recurring units (R*_{P1a}) of formula (N1), said mol. % being based on the total number of moles of recurring units in the graft PAE copolymer (P1): 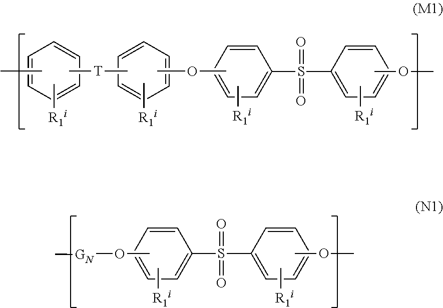
or
collectively at least 50 mol. % of ketone recurring units (R_{P1b}) of formula (M2) and functionalized ketone recurring units (R*_{P1b}) of formula (N2), said mol. % being based on the total number of moles of recurring units in the graft PAE copolymer (P1): 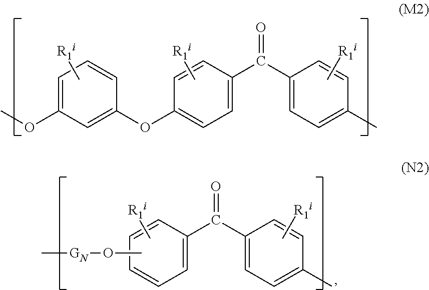
wherein the molar ratio of recurring units (R_{P1a})/recurring units (R*_{P1a}) or recurring units (R_{P1b})/recurring units (R*_{P1b}) is at least 1/5 and at most 100/1; and
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4;
T is selected from the group consisting of a bond; —C(CH₃)₂—; —SO₂—; —O—; —S—; —C(O)—; —C(CF₃)₂—; —C(═CCl₂)—; —C(CH₃)(CH₂CH₂COOH)—; —N═N—; and —RₐC═CR_{b}—, where each Rₐ and R_{b}, independently of one another, is a hydrogen or a C1-C12-alkyl, C1-C12-alkoxy, or C6-C18-aryl group; —(CH₂)ₘ and —(CF₂)ₘ— with m being an integer from 1 to 6; an aliphatic divalent group, linear or branched, of up to 6 carbon atoms; and combinations thereof;
G_{N} is selected from the group consisting of the following formulae (G_{N1}) to (G_{N10}) and any combinations thereof: 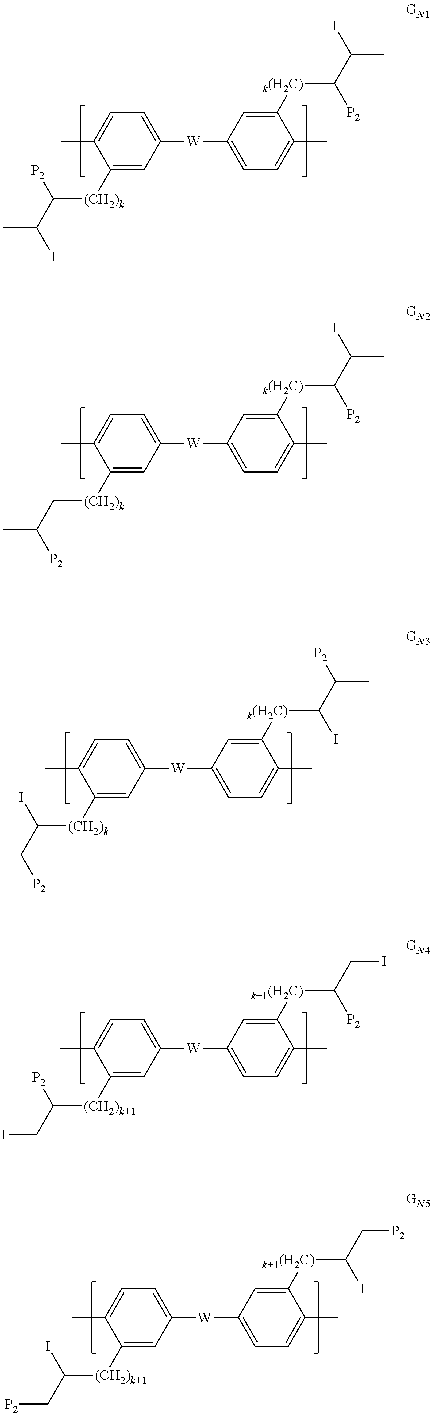 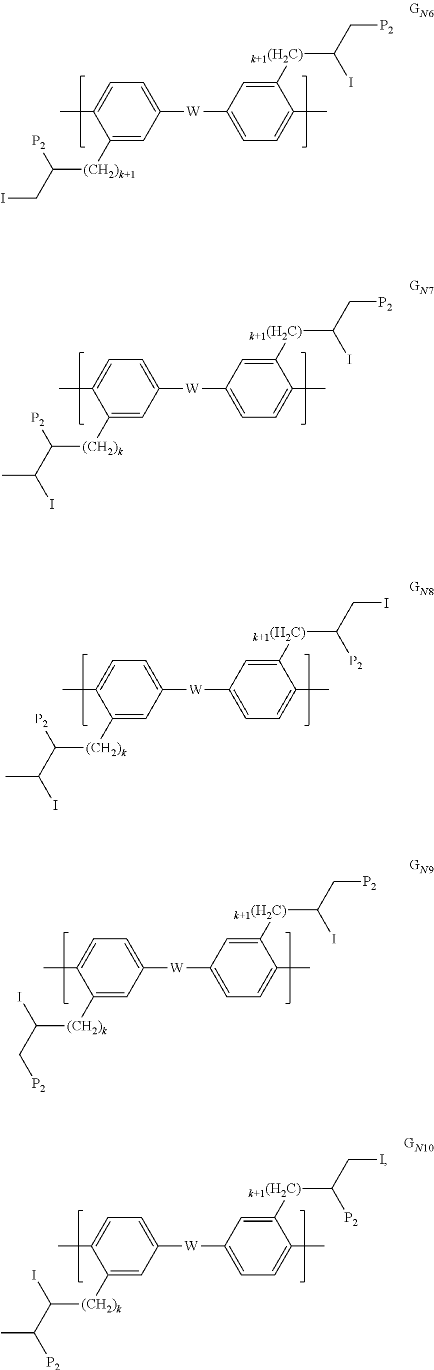
in which
W in the group G_{N} is selected from the group consisting of a bond, —SO₂—, —C(CH₃)₂— and any combination thereof,
each k in the group G_{N} is independently 0 or an integer from 1 to 4;
the two grafted polymers P₂ in the group G_{N}, being the same or different from each other, are grafted poly(vinylpyrrolidone) polymers (‘PVP’); and
the two I in the group G_{N}, being the same or different from each other, represent a fragment of a free radical initiator and/or a fragment of a PVP polymer.

2. The graft polyarylether copolymer (P1) of claim 1, wherein the sulfone recurring units (R_{P1a}) is of formula (M1a), (M1b), or (M1c): 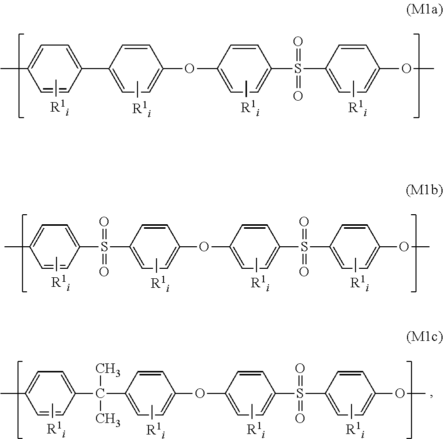
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each i is independently 0 or an integer from 1 to 4.

3. The graft polyarylether copolymer (P1) of claim 1, wherein i is zero for each R₁.

4. The graft polyarylether copolymer (P1) of claim 1, wherein the ketone recurring units (R_{P1b}) is of formula (M2a):

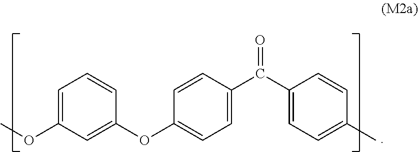

5. The graft polyarylether copolymer (P1) of claim 1, comprising collectively at least 80 mol. % of sulfone recurring units (R_{P1b}) and (R*_{P1b}) or ketone recurring units (R_{P1a}) and (R*_{P1a}), said mol. % being based on the total number of moles of recurring units in the graft PAE copolymer (P1).

6. The graft polyarylether copolymer (P1) of claim 1, wherein k is 0 in recurring units (R*_{P1a}) or (R*_{P1b}).

7. The graft polyarylether copolymer (P1) of claim 1, wherein the molar ratio of sulfone recurring units (R_{P1a})/recurring units (R*_{P1a}) or ketone recurring units (R_{P1b})/recurring units (R*_{P1b}) is from 1/4 to 50/1.

8. The graft polyarylether copolymer (P1) of claim 1, wherein each of the grafted polymer P₂ in the group G_{N} of any of the formulae (G_{N1}) to (G_{N10}) in recurring units (R*_{P1a}) or (R*_{P1b}) comprises at least 50 mol. % of recurring units Rp of formula (P): 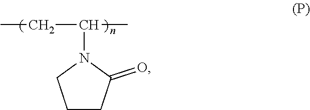
said mol. % being based on the total number of recurring units of the grafted polymer P₂, in which n in formula (P) is an integer of at least 3 and at most 200.

9. The graft polyarylether copolymer (P1) of claim 1, not being crosslinked.

10. The graft polyarylether copolymer (P1) of claim 1, containing less than 2 wt % of free vinyl pyrrolidone or free poly(vinyl pyrrolidone), based on the total weight of the graft PAE polymer (P1).

11. An amorphous side-chain olefin functionalized polyaryletherketone copolymer (P0) comprising:
collectively at least 50 mol. % of ketone recurring units (R_{P0b}) of formula (M2) and functionalized ketone recurring units (R*_{P0b}) of formula (N0′), said mol. % being based on the total number of moles of recurring units in the copolymer (P0): 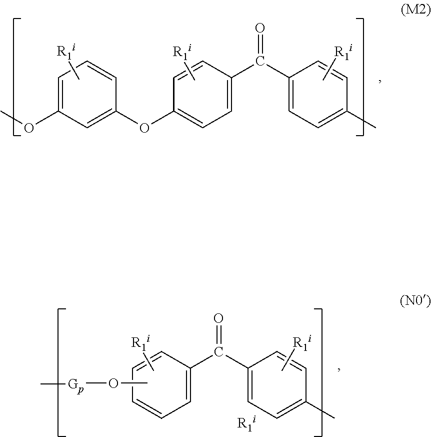
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4;
G_{P} is selected from the group consisting of at least one of the following formulae (G_{P1}), (G_{P2}) and (G_{P3}): 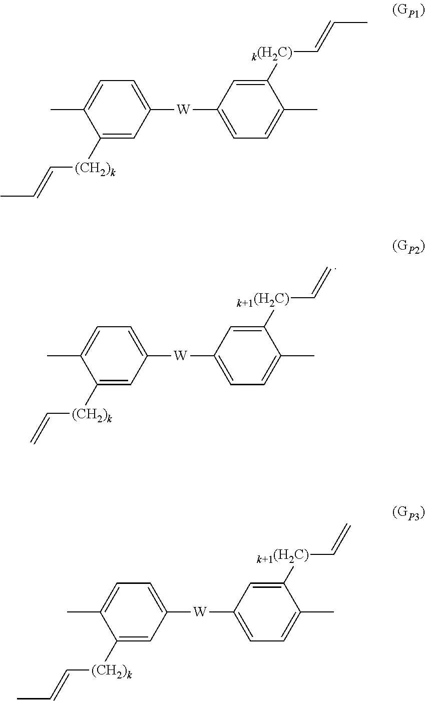
wherein
W in the group G_{P} is selected from —C(CH₃)₂— and/or a bond;
each k in the group G_{P} is independently 0 or an integer from 1 to 4; and
wherein the molar ratio of ketone recurring units (R_{P0b})/recurring units (R*_{P0b}) is at least 1/5 and at most 100/1.

12. (canceled)

13. A process for preparing the graft polyarylether copolymer (P1) of claim 1, comprising:
reacting, in a solvent S₁, a side-chain allyl/vinylidene-functionalized polyarylether copolymer (P0) with vinyl pyrrolidone monomer in the presence of at least one free radical initiator, to form the graft polyarylether copolymer (P1); and
removing any free poly(vinyl pyrrolidone) and optionally any unreacted vinyl pyrrolidone monomer and/or unreacted free radical initiator from the formed graft PAE copolymer (P1) to generate a purified the graft PAE copolymer (P1),
wherein the allyl/vinylidene-functionalized polyarylether copolymer (P0) comprises:
collectively at least 50 mol. % of sulfone recurring units (R_{P0a}) of formula (M1) and functionalized sulfone recurring units (R*_{P0a}) of formula (N0), said mol. % being based on the total number of moles of recurring units in the copolymer (P0): 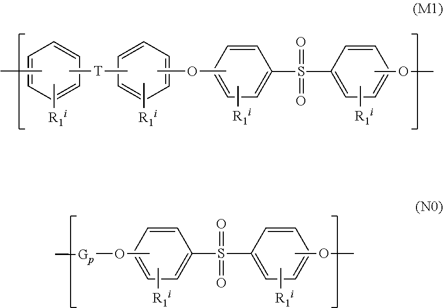
or
collectively at least 50 mol. % of ketone recurring units (R_{P0b}) of formula (M2) and functionalized ketone recurring units (R*_{P0b}) of formula (N0′), said mol. % being based on the total number of moles of recurring units in the copolymer (P0): 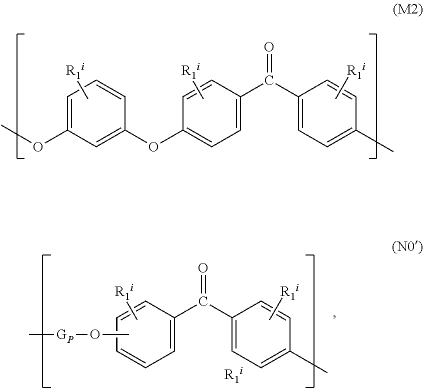
wherein
each R₁ is independently selected from the group consisting of a halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each i is independently 0 or an integer from 1 to 4;
T is selected from the group consisting of a bond; —C(CH₃)₂—; —SO₂—; —O—; —S—; —C(O)—; —C(CF₃)₂—; —C(═CCl₂)—; —C(CH₃)(CH₂CH₂COOH)—; —N═N—; and —RₐC═CR_{b}—, where each Rₐ and R_{b}, independently of one another, is a hydrogen or a C1-C12-alkyl, C1-C12-alkoxy, or C6-C18-aryl group; —(CH₂)ₘ— and —(CF₂)ₘ with m being an integer from 1 to 6; an aliphatic divalent group, linear or branched, of up to 6 carbon atoms; and combinations thereof;
G_{P} is selected from the group consisting of at least one of the following formulae (G_{P1}), (G_{P2}) and (G_{P3}): 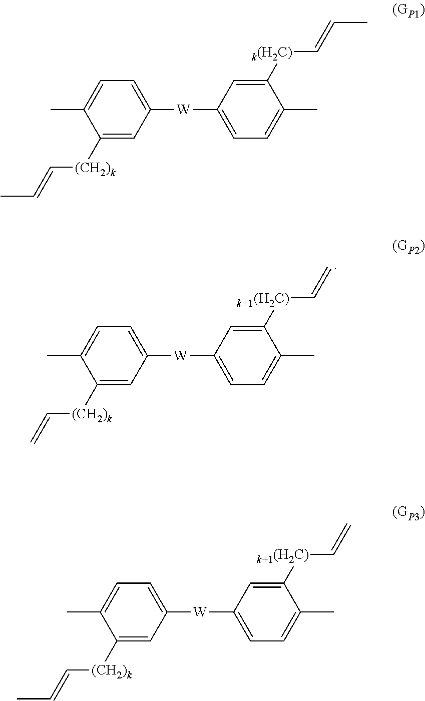
wherein
W in the group G_{P} is selected from the group consisting of a bond, —C(CH₃)₂—, —SO₂— and any combination thereof;
each k in the group G_{P} is independently 0 or an integer from 1 to 4; and
wherein the molar ratio of sulfone recurring units (R_{Poa})/recurring units (R*_{POa}) or ketone recurring units (R_{P0b})/recurring units (R*_{P0b}) is at least 1/5 and at most 100/1; and
wherein the number of moles of functionalized recurring units (R*_{POa}) or (R*_{P0b}) in the PAE copolymer (P0) used in the reaction mixture is n₁; the number of moles of vinyl pyrrolidone monomer used in the reaction mixture is n₂, and the molar ratio n₂/n₁ is at least 3 and at most 200.

14. The process of claim 13, wherein the reacting step is carried out with at least one of the following conditions:
in the presence of 2,2′-Azobis(2-methylpropionitrile) (AIBN) or 2,2′-azobis(2,4-dimethylvaleronitrile (ADVN) as at least one free radical initiator; and/or
the solvent S₁ being a polar aprotic solvent selected from the group consisting of 1,3-dimethyl-2-imidazolidinone (DMI), dimethylsulfoxide (DMSO), dimethylsulfone (DMS02), diphenylsulfone, diethylsulfoxide, diethylsulfone, diisopropylsulfone, tetrahydrothiophene-1,1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof; and/or
at a reaction temperature from 10° C. to 200° C.; and/or
in the absence of a crosslinking agent, in the absence of radiation and/or in the absence of radiation initiator.

15. A method for preparing an article, comprising forming the article from a solution comprising the graft polyarylether copolymer (P1) of claim 1.

16. An article comprising the graft polyarylether copolymer (P1) of claim 1.

17. The article according to claim 16, being selected from the group consisting of membranes; fibers; sheets; solution processed films; and solution processed monofilaments.

18. The article according to claim 16, being a membrane or a part of a membrane, said membrane being selected from the group consisting of proton exchange membranes, membranes for bioprocessing, hemodialysis membranes, membranes for food and beverage filtration, and membranes for water purification.

19. The graft polyarylether copolymer (P1) of claim 1, wherein T is selected from the group consisting of a bond, —C(CH₃)₂— and —SO₂—.

20. The graft polyarylether copolymer (P1) of claim 1, wherein the molar ratio of sulfone recurring units (R_{P1a})/recurring units (R*_{P1a}) or ketone recurring units (R_{P1b})/recurring units (R*_{P1b}) is from 1/3 to 40/1.
